(19) United States
(12) Patent Application Publication
(10) Pub. No.: US 2025/0031027 A1
(43) Pub. Date: Jan. 23, 2025

(54) ELECTRONIC DEVICE SUPPORTING MULTIPLE SUBSCRIBER IDENTITY MODULES AND OPERATING METHOD THEREOF

(71) Applicant: SAMSUNG ELECTRONICS CO., LTD., Suwon-si (KR)

(72) Inventors: Jaehong KIM, Suwon-si (KR); Subin Kim, Suwon-si (KR); Youngseon Jeon, Suwon-si (KR)

(73) Assignee: SAMSUNG ELECTRONICS CO., LTD., Suwon-si (KR)

(21) Appl. No.: 18/778,504

(22) Filed: Jul. 19, 2024

Related U.S. Application Data
(63) Continuation of application No. PCT/KR2024/009307, filed on Jul. 2, 2024.

(30) Foreign Application Priority Data
Jul. 20, 2023 (KR) 10-2023-0094483
Aug. 24, 2023 (KR) 10-2023-0111444

(51) Int. Cl. H04W 8/18; H04W 4/80; H04W 88/06

(52) U.S. Cl. CPC H04W 8/183; H04W 4/80; H04W 88/06

(57) ABSTRACT

An electronic device includes: a near field communication (NFC) circuit; at least one processor operatively connected to the NFC circuit; and memory storing instructions that, when executed by the at least one processor, cause the electronic device to: receive, via the NFC circuit from an external electronic device, an NFC application identifier (ID), identify a subscriber identity module (SIM) profile, from among a plurality of SIM profiles, that corresponds to the NFC application ID, and perform, via the NFC circuit, an NFC communication with the external electronic device based on the identified SIM profile.

### CROSS-REFERENCE TO RELATED APPLICATIONS

This application is a continuation application of International Application No. PCT/KR2024/009307, filed on Jul. 2, 2024, which claims priority to Korean Patent Application No. 10-2023-0094483, filed on Jul. 20, 2023, and Korean Patent Application No. 10-2023-0111444, filed on Aug. 24, 2023, in the Korean Intellectual Property Office, the disclosures of which are incorporated by reference herein in their entireties.

### BACKGROUND

### 1. Field

The disclosure relates generally to electronic devices, and more particularly, to an electronic device supporting a plurality of subscriber identity modules (SIMs) and an operating method thereof.

### 2. Description of Related Art

In a wireless communication system of the related art, an electronic device (e.g., a user equipment (UE)) may access a wireless communication network and may use a communication service such as a voice communication service and/or a data communication service at a fixed location and/or while moving.

To provide the electronic device with the communication service, a suitable authenticating process may be performed. For example, a universal integrated circuit card (UICC) may be inserted into the electronic device, and the authenticating process may be performed between the electronic device and a server of a communication provider (e.g., a mobile network operator (MNO)) via a universal subscriber identity module (USIM) installed in the UICC. The UICC may be referred to as a subscriber identity module (SIM) card in a global system for mobile communications (GSM) scheme and may be referred to as a universal subscriber identity module (USIM) card in a wideband code division multiple access (WCDMA), long term evolution (LTE), and/or new radio (NR) schemes.

When a user of the electronic device subscribes to a communication service provided by the communication provider, the communication provider may provide the user with a UICC (e.g., a SIM card or a USIM card), and the user may insert the UICC provided from the communication provider into the electronic device. When the UICC is inserted into the electronic device, a USIM application installed in the UICC may be executed, and the suitable authenticating process may be performed, based on an encryption key value for authentication and an international mobile subscriber identity (IMSI) value stored in the UICC, with the server of the communication provider at which the same and/or a corresponding IMSI value and encryption key value are stored. When authentication for the electronic device via the authenticating process is successful, the electronic device may use (and/or may be permitted to use) the communication service.

When information related to the SIM is provided to the UICC (e.g., an embedded subscriber identity module (eSIM) and/or an integrated subscriber identity module (iSIM)) on the electronic device from the server of the communication service provider, the suitable authenticating process may be performed with the server of the communication service provider at which the same and/or corresponding IMSI value and encryption key are stored, based on the IMSI value and encryption key value for the authentication that may be included in the information related to the SIM or may be generated based on the information related to the SIM. If the authentication for the electronic device is successful via the authenticating process, the electronic device may use (and/or may be permitted to use) the communication service.

The electronic device may support two or more SIMs, and the electronic device supporting the two or more SIMs may be referred to as a dual SIM electronic device and/or a multi-SIM electronic device.

For example, when two or more SIM cards are mounted in the electronic device, two or more independent UICCs may be configured in the electronic device. Alternatively, when the two or more SIM cards are mounted in the electronic device, at least one independent UICC and at least one eSIM card may be configured in the electronic device. As another example, when the two or more SIM cards are mounted in the electronic device, at least one independent UICC and at least one iSIM card may be configured in the electronic device. Alternatively, when the two or more SIM cards are mounted in the electronic device, an eSIM card and/or an iSIM card that may support at least two networks may be configured in the electronic device. The dual SIM electronic device and/or the multi-SIM electronic device may support a plurality of SIMs and may be associated with a subscription set for each SIM.

A state in which one transceiver transmits and receives signals associated with two SIMs may be referred to as a dual SIM dual standby (DSDS) mode. In the DSDS mode, when one of the two SIMs transmits and/or receives a signal (e.g., when one of the two SIMs operates in an active state), the other SIM may operate in a standby state. Alternatively, a state in which the two SIMs may simultaneously operate in the active state via a plurality of transceivers may be referred to as a dual SIM dual active (DSDA) mode.

### SUMMARY

Provided are an electronic device supporting a plurality of subscriber identity modules and an operating method thereof.

Further, provided are an electronic device for selecting a subscriber identity module (SIM) profile related to an near field communication (NFC) service and an operating method thereof.

Further, provided are an electronic device for adaptively selecting a SIM profile related to an NFC service without user manipulation and an operating method thereof.

According to an aspect of the disclosure, an electronic device includes: a near field communication (NFC) circuit; at least one processor operatively connected to the NFC circuit; and memory storing instructions that, when executed by the at least one processor, cause the electronic device to: receive, via the NFC circuit from an external electronic device, an NFC application identifier (ID), identify a subscriber identity module (SIM) profile, from among a plurality of SIM profiles, that corresponds to the NFC application ID, and perform, via the NFC circuit, an NFC communication with the external electronic device based on the identified SIM profile.

The instructions stored in the memory, when executed by the at least one processor, may further cause the electronic device to: identify the SIM profile, from among the plurality of SIM profiles, that corresponds to the NFC application ID based on a database including information related to at least one SIM profile in which at least one NFC application is installed, and an NFC application corresponding to the NFC application ID is installed in the identified SIM profile.

The instructions stored in the memory, when executed by the at least one processor, may further cause the electronic device to: identify whether the identified SIM profile is enabled, and based on identifying that the identified SIM profile is disabled, enable the identified SIM profile, perform via the NFC circuit, the NFC communication with the external electronic device, and disable the identified SIM profile based on the NFC communication being completed.

The instructions stored in the memory, when executed by the at least one processor, may further cause the electronic device to: based on identifying that the identified SIM profile is disabled, enable the identified SIM profile, and perform, via the NFC circuit, the NFC communication with the external electronic device by enabling the identified SIM profile.

The electronic device may further include a switch operatively coupled with the at least one processor, the instructions stored in the memory, when executed by the at least one processor, may further cause the electronic device to: identify whether the identified SIM profile is enabled, based on identifying that the identified SIM profile is enabled, identify whether a SIM corresponding to the identified SIM profile is connected to the NFC circuit via the switch, and based on identifying that the SIM corresponding to the identified SIM profile is connected to the NFC circuit via the switch, perform, via the NFC circuit, the NFC communication with the external electronic device based on the identified SIM profile, and the switch is configured to connect the NFC circuit to one of at least two of a first SIM, a second SIM, or an embedded subscriber identity module (eSIM).

The instructions stored in the memory, when executed by the at least one processor, may further cause the electronic device to: based on identifying that the SIM corresponding to the identified SIM profile is not connected to the NFC circuit via the switch, connect the SIM corresponding to the identified SIM profile to the NFC circuit via the switch, and perform, via the NFC circuit, the NFC communication with the external electronic device based on the identified SIM profile.

The instructions stored in the memory, when executed by the at least one processor, may further cause the electronic device to: based on identifying that the identified SIM profile is disabled, enable the identified SIM profile; identify whether a SIM corresponding to the identified SIM profile is connected to the NFC circuit via the switch, and based on identifying that the SIM corresponding to the identified SIM profile is connected to the NFC circuit via the switch, perform, via the NFC circuit, the NFC communication with the external electronic device based on the identified SIM profile.

The instructions stored in the memory, when executed by the at least one processor, may further cause the electronic device to: based on identifying that the SIM corresponding to the identified SIM profile is not connected to the NFC circuit via the switch, connect the SIM corresponding to the identified SIM profile to the NFC circuit via the switch, and perform, via the NFC circuit, the NFC communication with the external electronic device based on the identified SIM profile.

The identified SIM profile is included in a multiple enabled profile (MEP) eSIM including at least two SIM profiles, a port is allocated to each of the at least two SIM profiles, and the instructions stored in the memory, when executed by the at least one processor, may further cause the electronic device to: identify whether a port corresponding to the identified SIM profile is connected to the NFC circuit; and based on identifying that the port corresponding to the identified SIM profile is connected to the NFC circuit, perform, via the NFC circuit, the NFC communication with the external electronic device based on the identified SIM profile.

The instructions stored in the memory, when executed by the at least one processor, may further cause the electronic device to: based on identifying that the port corresponding to the identified SIM profile is not connected to the NFC circuit, identify whether the identified SIM profile is enabled; based on identifying that the identified SIM profile is enabled, change the port connected to the NFC circuit to another port corresponding to the identified SIM profile; and perform, via the NFC circuit, the NFC communication with the external electronic device based on the identified SIM profile.

The instructions stored in the memory, when executed by the at least one processor, may further cause the electronic device to: based on identifying that the identified SIM profile is disabled, enable the identified SIM profile, change the port connected to the NFC circuit to the another port corresponding to the identified SIM profile, and perform, via the NFC circuit, the NFC communication with the external electronic device based on the identified SIM profile.

The instructions stored in the memory, when executed by the at least one processor, may further cause the electronic device to, based on identifying termination of the NFC communication, change the port connected to the NFC circuit from the port corresponding to the identified SIM profile to another port previously coupled with the NFC circuit before the port corresponding to the identified SIM profile.

The instructions stored in the memory, when executed by the at least one processor, may further cause the electronic device to generate the database by mapping, to each of the at least one NFC application, a name of the NFC application, identification information of a SIM profile in which the NFC application is installed, and state information indicating whether the SIM profile in which the NFC application is installed is enabled.

The instructions stored in the memory, when executed by the at least one processor, may further cause the electronic device to generate the database by mapping a service provided by the NFC application to each of the at least one NFC application.

According to an aspect of the disclosure, a method includes: receiving, from an external electronic device, a near field communication (NFC) application identifier (ID); identifying a subscriber identity module (SIM) profile, from among a plurality of SIM profiles, that corresponds to the NFC application ID; and performing an NFC communication with the external electronic device based on the identified SIM profile.

The identifying the SIM profile may include identifying the SIM profile based on a database including information related to at least one SIM profile in which at least one NFC application is installed, and an NFC application corresponding to the NFC application ID is installed in the identified SIM profile.

The performing of the NFC communication may include: identifying whether the identified SIM profile is enabled; and based on identifying that the identified SIM profile is disabled, enabling the identified SIM profile and performing the NFC communication with the external electronic device by enabling the identified SIM profile.

The performing the NFC communication may include: based on identifying that the identified SIM profile is disabled, enabling the identified SIM profile; and performing the NFC communication with the external electronic device by enabling the identified SIM profile.

The performing of the NFC communication may include: identifying whether the identified SIM profile is enabled;
based on identifying that the identified SIM profile is enabled, identifying whether a SIM corresponding to the identified SIM profile is connected to an NFC circuit via a switch; and
based on identifying that the SIM corresponding to the identified SIM profile is connected to the NFC circuit via the switch, performing the NFC communication with the external electronic device based on the identified SIM profile, and the switch connects the NFC circuit to one of at least two of a first SIM, a second SIM, or an embedded subscriber identity module (eSIM).

The method may further include generating the database by mapping, to each of the at least one NFC application, a name of the NFC application, a number of a SIM profile in which the NFC application is installed, and state information indicating whether the SIM profile in which the NFC application is installed is enabled.

Additional aspects may be set forth in part in the description that follows and, in part, may be apparent from the description, and/or may be learned by practice of the presented embodiments.

### BRIEF DESCRIPTION OF THE DRAWINGS

The above and other aspects, features, and advantages of certain embodiments of the disclosure will become apparent from the following description taken in conjunction with the accompanying drawings, in which:

FIG. 1A is a block diagram schematically illustrating an electronic device in a network environment, according to an embodiment;

FIG. 1B is a diagram illustrating a network environment including an electronic device, according to an embodiment;

FIG. 2 is a block diagram schematically illustrating an electronic device, according to an embodiment;

FIG. 3 is a block diagram schematically illustrating an electronic device, according to an embodiment;

FIG. 4 is a block diagram schematically illustrating an electronic device, according to an embodiment;

FIG. 5 is a block diagram schematically illustrating an electronic device, according to an embodiment;

FIG. 6 is a block diagram schematically illustrating an electronic device, according to an embodiment;

FIG. 7 is a block diagram schematically illustrating an electronic device, according to an embodiment;

FIG. 8 is a flowchart depicting an example of an operating method of an electronic device, according to an embodiment;

FIG. 9 is a signal flowchart illustrating an example of an operating method of an electronic device in a wireless communication system, according to an embodiment; and

FIG. 10 is a flowchart depicting an example of an operating method of an electronic device, according to an embodiment.

### DETAILED DESCRIPTION

Hereinafter, various embodiments of the disclosure various described with reference to the accompanying drawings. In the following description of various embodiments of the disclosure, a detailed description of relevant known functions or configurations incorporated herein may be omitted when the description may make the subject matter of an embodiment of the disclosure unnecessarily unclear. The terms that are described below are terms defined in consideration of the functions in the disclosure, and may be different according to users, intentions of the users, and/or customs. Therefore, the definitions of the terms should be made based on the contents throughout the disclosure.

It is to be understood that the technical terms used herein are only used to describe a specific embodiment, and are not intended to limit an embodiment of the disclosure. In addition, the technical terms used herein should be interpreted to have the same meaning as those commonly understood by a person skilled in the art to which the disclosure pertains, and should not be interpreted have excessively comprehensive or excessively restricted meanings unless particularly defined as other meanings. When the technical terms used herein are wrong technical terms that cannot correctly represent the idea of the disclosure, it should be appreciated that the incorrect technical terms are replaced by technical terms correctly understood by those skilled in the art. The general terms used in an embodiment of the disclosure should be interpreted as defined in dictionaries or interpreted in the context of the relevant part, and should not be interpreted to have excessively restricted meanings.

It is to be understood that a singular expression used herein may include a plural expression unless the relevant context clearly indicates otherwise. As used herein, an expression such as “comprises” or “include”, or the like should not be interpreted to necessarily include all elements or all operations described in the disclosure, and should be interpreted to be allowed to exclude some elements or further include additional elements or operations.

As used herein, the terms including an ordinal number, such as “a first”, “a second”, or the like, may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, the element may be connected or coupled directly to the other element, or any other element may be interposed between the two elements. In addition, it should be understood that when an element is referred to as being “directly connected” or “directly coupled” to another element, there may be no element interposed between the two elements.

Hereinafter, an embodiment of the disclosure will be described in detail with reference to the accompanying drawings. Regardless of drawing signs, the same or like elements are provided with the same reference numeral, and a repeated description thereof may be omitted. In addition, in describing an embodiment of the disclosure, a detailed description of relevant known technologies may be omitted when the description may make the subject matter of the disclosure unclear. That is, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Reference throughout the disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, an electronic device is described in an embodiment of the disclosure, and the electronic device may be referred to as a terminal, a mobile station, a mobile equipment (ME), a user equipment (UE), a user terminal (UT), a subscriber station (SS), a wireless device, a handheld device, and an access terminal (AT). Alternatively or additionally, in an embodiment of the disclosure, the electronic device may be and/or may include a device having a communication function such as, for example, a mobile phone, a personal digital assistant (PDA), a smart phone, a wireless modem, or a notebook.

Hereinafter, various embodiments of the disclosure are described with reference to the accompanying drawings.

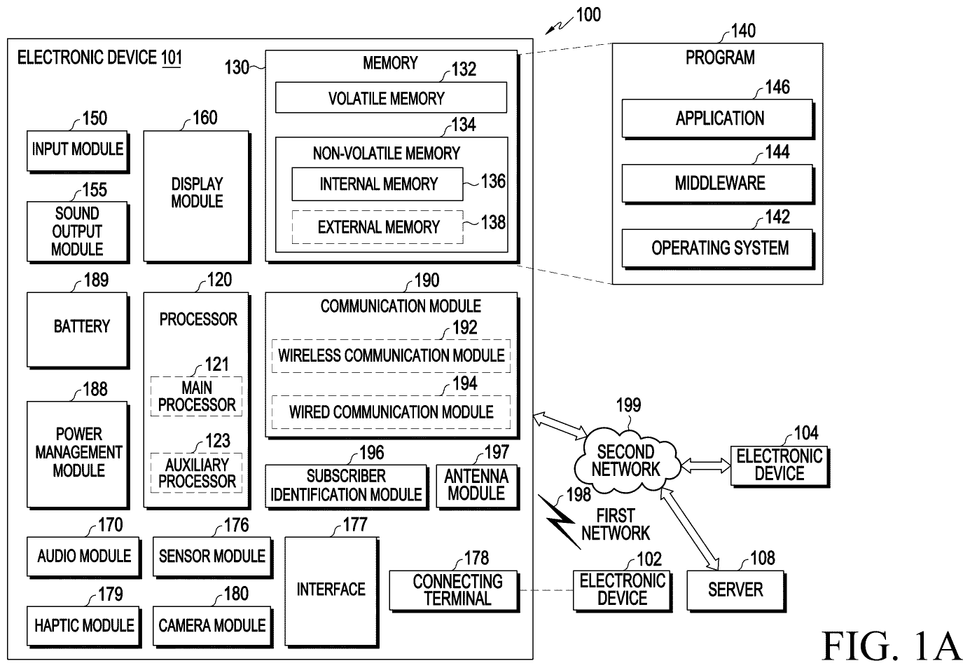

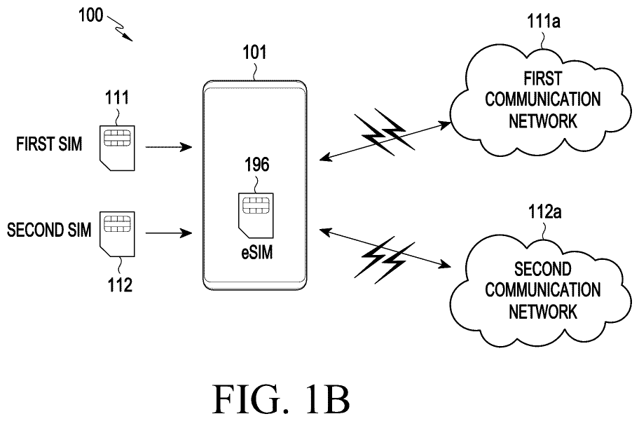

FIG. 1A is a block diagram illustrating an electronic device 101 in a network environment 100, according to an embodiment.

Referring to FIG. 1A, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (cMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to an embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to.” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

FIG. 1B is a diagram illustrating a network environment 100 including an electronic device, according to an embodiment.

Referring to FIG. 1B, the network environment 100, according to an embodiment, may include the electronic device 101, a first communication network 111a, and a second communication network 112a. The electronic device 101 of FIG. 1B may include and/or may be similar in many respects to the electronic device 101 described above with reference to FIG. 1A, and may include additional features not mentioned above. Consequently, repeated descriptions of the electronic device 101 described above with reference to FIG. 1A may be omitted for the sake of brevity.

Although FIG. 1B illustrates the network environment 100 as having two (2) communication networks (e.g., the first and second communication networks 111a and 112a), the disclosure is not limited in this regard. For example, the network environment 100 may include additional communication networks, such as a third communication network.

According to an embodiment, the electronic device 101 may operate in a dual SIM dual standby (DSDS) mode supporting a plurality of SIMs. The DSDS mode may represent a state in which one transceiver may transmit and/or receive signals associated with two SIMs. In the DSDS mode, if one of the two SIMs transmits and/or receives a signal (e.g., if the one of the two SIMs exists or operates in an active state), the other SIM of the two SIMs may exist or operate in a standby state.

According to an embodiment, the electronic device 101 may operate in a dual SIM dual active (DSDA) mode that supports a plurality of SIMs. The DSDA mode may represent a state in which two SIMs may simultaneously (and/or at a substantially similar time) operate in an active state via a plurality of transceivers.

In an embodiment, at least two SIMs may be mounted in the electronic device 101, and the at least two SIMs may include a first SIM 111 and a second SIM 112. The first SIM 111 and the second SIM 112 may be removable SIMs (rSIMs). An rSIM may refer to a SIM that may be removable from a slot provided in the electronic device 101. The disclosure is not limited as to a form and/or standard of the rSIM. For example, the electronic device 101 may be equipped with two SIM cards to support two SIMs. Although for convenience of description, the first SIM 111 and the second SIM 112 are illustrated as SIM cards in FIG. 1B, the disclosure is not limited in this regard. That is, the first SIM 111 and the second SIM 112 may not be limited to only a SIM card. For example, one of the first SIM 111 or the second SIM 112 may be and/or may include an embedded subscriber identity module (eSIM), an integrated subscriber identity module (iSIM), or the like.

In an embodiment, the electronic device 101 may include an eSIM 196 (e.g., the SIM 196 of FIG. 1A). For example, the electronic device 101 may be implemented to include only the eSIM 196, and the eSIM 196 may include a plurality of profiles, and may enable any one of the plurality of profiles.

The electronic device 101 may be implemented to include a slot on which the eSIM 196 and one or more SIMs may be mounted. For example, the electronic device 101 may perform a dual SIM-based operation that may be based on information stored in an rSIM inserted (or connected) to the slot and profiles enabled by the eSIM 196. The electronic device 101 may perform the dual SIM-based operation based on two rSIMs. However, the disclosure is not limited in this regard. For example, at least one of the first SIM 111 or the second SIM 112 may be replaced with an eSIM and/or an iSIM. In such an example, at least some of the information stored in the rSIM may be replaced with information of the profiles enabled by the eSIM 196. Hereinafter, for convenience of a description, a SIM card may be used interchangeably with a SIM.

In an embodiment, the electronic device 101 may include a multiple enabled profile (MEP) eSIM. For example, the electronic device 101 may be implemented to include only the MEP eSIM, and the MEP eSIM may include a plurality of profiles, and may enable at least two profiles of the plurality of profiles.

An electronic device may support two or more SIMs, and the electronic device supporting the two or more SIMs may be referred to as a dual SIM electronic device, or a multi-SIM electronic device. The dual SIM electronic device may be implemented to support two removable SIMs, may be implemented to support one removable SIM and an eSIM, and/or may be implemented to support an MEP eSIM. An rSIM may be referred to as a physical SIM (pSIM). An electronic device supporting two rSIMs may be implemented to include two slots capable of accommodating two rSIMs. An electronic device supporting one rSIM and an eSIM may include a slot capable of accommodating one SIM and the eSIM.

As illustrated in FIG. 1B, the two SIM cards including the first SIM 111 and the second SIM 112 may be mounted on the electronic device 101. The electronic device 101 may include a first slot and a second slot inside electronic device 101 for accommodating the first SIM 111 and the second SIM 112, respectively.

For example, the first SIM 111 may be and/or may include a SIM subscribed to a communication provider of the first communication network 111a, and the electronic device 101 may receive a wireless communication service via the first communication network 111a by using the first SIM 111 to access the first communication network 111a. The second SIM 112 may be and/or may include a SIM subscribed to a communication provider of the second communication network 112a, and the electronic device 101 may receive a wireless communication service via the second communication network 112a by using the second SIM 112 to access the second communication network 112a. In an embodiment, the first communication network 111a and the second communication network 112a may be provided by the same communication provider. Alternatively, the first communication network 111a and the second communication network 112a may be provided by different communication providers. When the first communication network 111a and the second communication network 112a are provided by the same communication provider, the first communication network 111a and the second communication network 112a may refer to the same network. Alternatively or additionally, the different communication providers may share a communication network. For example, the first communication provider may use the first communication network 111a, and the second communication provider may also be set to use the first communication network 111a. According to an embodiment, the electronic device 101 may further include at least one SIM. That is, the disclosure is not limited to the number or type of SIMs that the electronic device 101 may include.

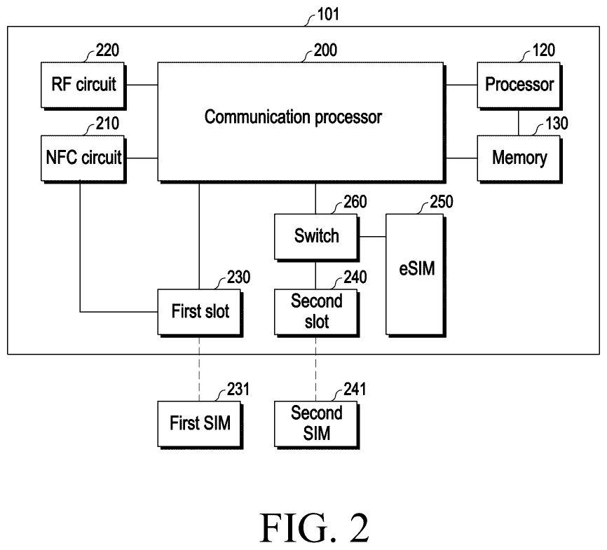

FIG. 2 is a block diagram schematically illustrating an electronic device, according to an embodiment.

Referring to FIG. 2, the electronic device 101 may include at least one of a processor 120, a communication processor 200, a near field communication (NFC) circuit 210, a radio frequency (RF) circuit 220, the memory 130, a first slot 230, a second slot 240, an eSIM 520, or a switch 260.

The electronic device 101 of FIG. 2 may include and/or may be similar in many respects to the electronic device 101 described above with reference to FIGS. 1A and 1B, and may include additional features not mentioned above. Furthermore, the processor 120 and the memory 130 of FIG. 2 may include and/or may be similar in many respects to the processor 120 and the memory 130 described above with reference to FIGS. 1A and 1B, and may include additional features not mentioned above. Consequently, repeated descriptions of the electronic device 101, and its components, described above with reference to FIGS. 1A and 1B may be omitted for the sake of brevity.

The communication processor 200 may establish a communication channel in a band that is used for a wireless communication, and may support a network communication through the established communication channel. For example, the communication processor 200 may support at least one of a 2nd generation (2G) network communication, a 3rd generation (3G) network communication, a 4th generation (4G) network communication, or a 5th generation (5G) network communication.

The NFC circuit 210 may interact with an external electronic device (e.g., the electronic devices 102 or 104 of FIG. 1A) having an NFC function. The external electronic device may include, but not be limited to, a point of sale (POS) device. The NFC circuit 210 may provide a wireless connection between the electronic device 101 and the external electronic device within a set radius (e.g., about four (4) centimeters (cm)). The NFC circuit 210 may operate in a card mode, and the card mode may refer to a mode in which the external electronic device may wait to wirelessly connect to the electronic device 101, and may transmit a set information (e.g., card information) in one direction if the external electronic device is wirelessly connected to the electronic device 101. For example, the NFC circuit 210 may operate in the card mode for a payment service such as, but not limited to, a credit card and/or a transportation card. As shown in FIG. 2, the NFC circuit 210 may be physically connected to the first slot 230.

The RF circuit 220 may include at least one of a radio frequency integrated circuit (RFIC), a radio frequency front end (RFFE) module, or an antenna module. The RF circuit 220 may convert data (e.g., a baseband signal) outputted from the communication processor 200 into an RF signal, and transmit the RF signal via the antenna module. Or, the RF circuit 220 may convert an RF signal received via the antenna module (e.g., the antenna module 197 of FIG. 1A) into a baseband signal, and transfer the baseband signal to the communication processor 200. The RF circuit 220 may process an RF signal or a baseband signal based on a communication scheme supported by the communication processor 200. The disclosure is not limited as to the type of the RF circuit 220. According to an embodiment, an interface between components may be implemented as a GPIO, a universal asynchronous receiver/transmitter (UART) (e.g., high speed-UART (HS-UART)), a peripheral component interconnect bus express (PCle) interface, or the like. The disclosure is not limited in this regard and various other interfaces may be established between the components. Alternatively or additionally, at least some of the components may exchange control information and/or packet data information using a shared memory.

Although FIG. 2 illustrates a case in which the processor 120 and the communication processor 200 are implemented as separate hardware, the disclosure is not limited in this regard. For example, in an embodiment, the processor 120 and the communication processor 200 may be implemented as separate hardware. Alternatively, the processor 120 and the communication processor 200 may be implemented in a single chip.

According to an embodiment, the communication processor 200 may perform an authenticating operation that may be based on information stored in a SIM. In an embodiment, the information stored in the SIM may refer to a SIM profile. The SIM profile may refer to a profile corresponding to (or stored in) the SIM or an eSIM.

The communication processor 200 may be connected to the first SIM 231 through the first slot 230. For example, the first SIM 231 may be connected to a stack (e.g., a protocol stack according to International Organization for Standardization/International Electrotechnical Commission ISO/IEC 7816) of the communication processor 200. In FIG. 2, the communication processor 200 may include two stacks. For example, the first slot 230 may accommodate the first SIM 231 that may be a pSIM (or an rSIM), and if the first SIM 231 is accommodated (e.g., if the first SIM 231 is mounted), the first slot 230 may include at least one terminal capable of transferring information from the first SIM 231 to the communication processor 200. The second slot 240 may accommodate the second SIM 241 that may be a pSIM (or an rSIM), and if the second SIM 241 is accommodated (e.g., if the second SIM 241 is mounted), the second slot 240 may include at least one terminal capable of transferring information from the second SIM 241 to the communication processor 200. A type of the first slot 230 may be the same as or different from a type of the second slot 240.

The communication processor 200 may obtain information (e.g., a first SIM profile) stored in the first SIM 231 from the first SIM 231 accommodated in the first slot 230. For example, in at least one of the first SIM 231, the second SIM 241, or the eSIM 250 (e.g., the eSIM 196 of FIG. 1A), at least one of an integrated circuit card ID (ICCID), an IMSI, home public land mobile network (HPLMN)-related information, or a mobile station international subscriber directory number (MSISDN) may be stored. The communication processor 200 may perform, via the RF circuit 220, an authenticating operation for a network communication that may correspond to the first SIM 231, based on the obtained information stored in the first SIM 231. If authentication is successful, the communication processor 200 may perform the network communication that corresponds to the first SIM 231 via the RF circuit 220. The communication processor 200 may perform an NFC communication with an external electronic device via the NFC circuit 210 based on the obtained information that may be stored in the first SIM 231.

According to an embodiment, at least one of the processor 120 or the communication processor 200 may control a state of the switch 260. The state of the switch 260 may be either a first state connecting the communication processor 200 and the second slot 240 or a second state connecting the communication processor 200 and the eSIM 250. For example, at least one of the processor 120 or the communication processor 200 may control the switch 260 to connect the second slot 240 to the communication processor 200. In an embodiment, at least one of the processor 120 or the communication processor 200 may provide the switch 260 with a control signal for controlling the state of the switch 260 to the first state. If a normal state in which the switch 260 does not receive a specific signal is the first state, at least one of the processor 120 or the communication processor 200 may perform no special operation to connect the second slot 240 to the communication processor 200. For example, a signal for controlling the switch 260 may be transferred through a GPIO, however, the disclosure is not limited as to an interface that may be used for transferring the signal for controlling the switch 260. In an embodiment, the state of the switch 260 may be controlled in a third state in which the switch 260 is not connected to the second slot 240 or to the eSIM 250. In an embodiment, the switch 260 may include at least one metal oxide semiconductor field effect transistor (MOSFET), or a freewheeling switch, however, the disclosure is not limited in this regard. The electronic device 101 may provide various applications (Apps) related to an NFC scheme. An App related to the NFC scheme may be referred to as an NFC App. Because the electronic device 101 may support a plurality of SIMs (e.g., the first SIM 111, the second SIM 112, and/or the eSIM 250), a user may distribute and install a plurality of NFC Apps across the plurality of SIMs. A SIM profile may refer to a profile corresponding to (or stored in) a SIM or an eSIM. In an embodiment, the profile may include a provisioning profile and an operational profile. For example, the operational profile may be and/or may include a profile including subscriber identity information of a user of the electronic device 101, and the provisioning profile may include information for downloading subscriber identity information or a profile including the subscriber identity information in the electronic device 101. According to an embodiment, the operational profile may further include, in addition to the subscriber identification information, at least one of network access authentication information of the subscriber, a phone book of the subscriber, or personal information of the subscriber (e.g., a short message service (SMS)), a subscribed communication provider name, available services, available data amount, fee, or a service provision speed, or information related to subscriber authentication and traffic security key generation upon accessing a wireless communication network such as, but not limited to, a global system for mobile communications (GSM) communication network, a wideband code division multiple access (WCDMA) communication network, a long-term evolution (LTE) communication network, and an NR communication network.

Even though the plurality of NFC Apps may be distributed and installed across the plurality of SIM profiles, for the NFC Apps, the electronic device 101 may execute only an NFC App installed in a SIM profile that may correspond to a SIM, which may be physically connected (e.g., accommodated in a slot), or which may be set by default, or which may be enabled, among the plurality of SIMs, as described in the following paragraphs.

### (1) Case 1

Assuming that the electronic device 101 is a dual SIM electronic device using two SIMs including the first SIM 231 and the second SIM 241, only NFC Apps, which may be stored in a profile corresponding to the first SIM 231 mounted in the slot 230 physically connected to the NFC circuit 210, may be used. Hereinafter, for convenience of description, the profile corresponding to the first SIM may be referred to as a first SIM profile. If NFC Apps stored in a profile corresponding to the second SIM 252 mounted in the second slot 240 that is not physically connected to the NFC circuit 210 need to be used, there may an inconvenience for the user to directly remove the first SIM 231 from the first slot 230, remove the second SIM 241 from the second slot 240, and then mount the second SIM 241 on the first slot 230 again.

### (2) Case 2

Assuming that the electronic device 101 is a dual SIM electronic device using two SIMs including the first SIM 231 and the eSIM 250, only NFC Apps, which may be stored in a profile corresponding to the first SIM 231 mounted in the slot 230 physically connected to the NFC circuit 210, may be used. If NFC Apps stored in a profile corresponding to the eSIM 250 that may not be physically connected to the NFC circuit 210 may need to be used, there may an inconvenience for the user to directly disable the first SIM profile and disable a profile corresponding to the eSIM 250.

### (3) Case 3

Assuming that the electronic device 101 is a dual SIM electronic device using an MEP eSIM including a plurality of SIM profiles, only NFC Apps stored in an enabled SIM profile (e.g., a SIM profile corresponding to an enabled port among the ports of an MEP) may be used. If an NFC App stored in a disabled SIM profile (e.g., a SIM profile corresponding to a disabled port from among the ports of the MEP) needs to be used, there may an inconvenience for the user to directly disable the enabled SIM profile, and enable the disabled SIM profile. In such an example, enablement of the SIM profile may be cumbersome for the user to directly enable a SIM profile in which an NFC App, which may need to be used via a separate menu manipulation, may be stored.

### (4) Case 4

Assuming that the electronic device 101 is a dual SIM electronic device using two pSIMs including the first SIM 231 and the second SIM 241 and one eSIM 250, a first NFC App, which may be an NFC App related to an employee ID card service, may be installed (or stored) in a first SIM profile that may correspond to the first SIM 231, a second NFC App that may be and/or may include an NFC App related to a transportation card service and a third NFC App that may be an NFC App related to a banking service may be installed (and/or stored) in a second SIM profile that may correspond to the second SIM 241, a fourth App, which may be and/or may include an NFC App related to a home key service, may be installed in a third SIM profile that may correspond to the eSIM 250, each of the first SIM profile and the second SIM profile may be enabled, and the third SIM profile may be disabled.

In order to use the second NFC App related to the transportation card service, a user may need to physically remove the first SIM 231 from the first slot 230 and physically mount the second SIM 241 on the second slot 240. If both the first SIM 231 and the second SIM 241 are an eSIM rather than a pSIM, there may an inconvenience for the user to directly manipulate a menu before tagging the electronic device 101 to an external electronic device (e.g., a POS device) to change a port connected to the NFC circuit 210 from the first SIM profile corresponding to the first SIM 231 to the second SIM profile corresponding to the second SIM 241. If the electronic device 101 supports only eSIMs (or only an MEP eSIM), the electronic device 101 may need to provide a menu for manipulating a connection between the NFC circuit 210 and ports that may correspond to eSIM profiles corresponding to eSIMs and a corresponding interface.

In order for the user to use the fourth NFC App, which may be the NFC App related to the home key service installed in the disabled third SIM profile, the electronic device 101 may disable one of the activated first SIM profile and second SIM profile, and may enable the disabled third SIM profile. In addition, the user may need to directly manipulate the menu to connect the NFC circuit 210 to the port corresponding to the third SIM profile, which may result in an inconvenience to the user.

For cases 1 to 4, the user may find difficult to remember which NFC App is installed (or stored) in each SIM profile, and there may be an inconvenience for the user to directly manipulate the menu before tagging the electronic device to the external electronic device, which may reduce speed and convenience of using the NFC function.

An embodiment of the disclosure may provide an electronic device supporting a plurality of subscriber identity modules and an operating method thereof.

An embodiment of the disclosure may provide an electronic device for selecting a SIM profile related to an NFC service and an operating method thereof.

An embodiment of the disclosure may provide an electronic device for adaptively selecting a SIM profile related to an NFC service without user manipulation and an operating method thereof.

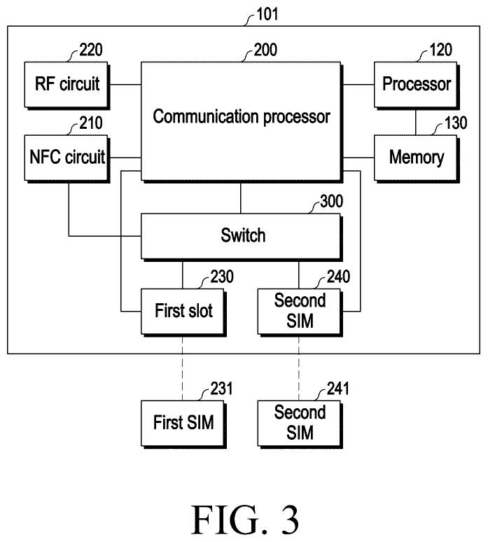

FIG. 3 is a block diagram schematically illustrating an electronic device, according to an embodiment.

Referring to FIG. 3, the electronic device 101 may include at least one of the processor 120, a communication processor 200, the NFC circuit 210, the RF circuit 220, the memory 130, the first slot 230, the second slot 240, or a switch 300.

The electronic device 101 of FIG. 3 may include and/or may be similar in many respects to the electronic device 101 described above with reference to FIGS. 1A, 1B, and 2, and may include additional features not mentioned above. Furthermore, the components of the electronic device 101 of FIG. 3 may include and/or may be similar in many respects to the respective components of the electronic device 101 described above with reference to FIGS. 1A, 1B, and 2, and may include additional features not mentioned above. Consequently, repeated descriptions of the electronic device 101, and its components, described above with reference to FIGS. 1A, 1B, and 2 may be omitted for the sake of brevity.

As shown in FIG. 3, the electronic device 101 may use the first SIM 231 and the second SIM 241, and each of the first SIM 231 and the second SIM 241 may be and/or may include a pSIM (or an rSIM).

The communication processor 200 may support establishment of a communication channel in a band to be used for a wireless communication, and a network communication via the established communication channel. For example, the communication processor 200 may support at least one of a 2G network communication, a 3G network communication, a 4G network communication, or a 5G network communication.

The NFC circuit 210 may interact with an external electronic device (e.g., the electronic device 102 or the electronic device 104 of FIG. 1A) having an NFC function. The external electronic devices 102 and 104 may be and/or may include a POS device. The NFC circuit 210 may provide a wireless connection between the electronic device 101 and the external electronic device within a set radius (e.g., about four (4) cm). The NFC circuit 210 may operate in a card mode, and the card mode may be implemented similarly to and/or substantially the same as described with reference to FIG. 2, consequently, a repeated description thereof may be omitted for the sake of brevity.

The RF circuit 220 may include at least one of an RFIC, an RFFE module, or an antenna module. The RF circuit 220 may convert data (e.g., a baseband signal) outputted from the communication processor 200 into an RF signal and may transmit the RF signal via the antenna module. The RF circuit 220 may convert an RF signal received via the antenna module (e.g., the antenna module 197 of FIG. 1A) into a baseband signal and may transfer the baseband signal to the communication processor 200. The RF circuit 220 may process an RF signal and/or a baseband signal based on a communication scheme supported by the communication processor 200. The disclosure is not limited as to the type of the RF circuit 220. The RF circuit 220 may be implemented similarly to and/or substantially the same as that described with reference to FIG. 2, consequently, a repeated description thereof may be omitted for the sake of brevity.

Although FIG. 3 illustrates the processor 120 and the communication processor 200 implemented as separate hardware, this is merely an example and the disclosure is not limited in this regard. In an embodiment, the processor 120 and the communication processor 200 may be implemented as separate hardware. Alternatively, the processor 120 and the communication processor 200 may be implemented on a single chip.

According to an embodiment, the communication processor 200 may perform an authenticating operation based on information stored in a SIM. In an embodiment, the information stored in the SIM may refer to a SIM profile. The SIM profile may refer to a profile corresponding to (or stored in) the SIM or an eSIM.

The communication processor 200 may be connected to the first SIM 231 via the first slot 230. For example, the first SIM 231 may be connected to a stack (e.g., a protocol stack according to ISO/IEC 7816) of the communication processor 200. In an embodiment, the communication processor 200 may include two stacks. For example, the first slot 230 may accommodate the first SIM 231, which may be and/or may include a pSIM (or an rSIM), and the first slot 230 may include at least one terminal capable of transferring information from the first SIM 231 to the communication processor 200 if the first SIM 231 is accommodated (e.g., if the first SIM 231 is mounted). The second slot 240 may accommodate the second SIM 241, which may be and/or may include a pSIM (or an rSIM), and the second slot 240 may include at least one terminal capable of transferring information from the second SIM 241 to the communication processor 200 if the second SIM 241 is accommodated (e.g., if the second SIM 241 is mounted). A type of the first slot 230 may be the same as or different from a type of the second slot 240.

The communication processor 200 may obtain information (e.g., a first SIM profile) stored in the first SIM 231 from the first SIM 231 accommodated in the first slot 230. For example, in at least one of the first SIM 231 or the second SIM 241, at least one of an ICCID, an IMSI, HPLMN-related information, or an MSISDN may be stored. The communication processor 200 may perform, via the RF circuit 220, an authenticating operation for a network communication that may correspond to the first SIM 231, based on the obtained information stored in the first SIM 231. If authentication is successful, the communication processor 200 may perform the network communication that may correspond to the first SIM 231 via the RF circuit 220. The communication processor 200 may perform an NFC communication with an external electronic device via the NFC circuit 210 based on the obtained information that is stored in the first SIM 231.

In an embodiment, the communication processor 200 may connect the NFC circuit 210 to one of the first slot 230 and the second slot 240 via the switch 300. In an embodiment, when receiving an NFC App ID from an external electronic device (e.g., a POS device) via the NFC circuit 210, the communication processor 200 may identify, based on a database stored in the memory 130, a SIM profile in which an NFC App corresponding to the NFC App ID is installed, and perform an NFC communication with the external electronic device based on the identified SIM profile via the NFC circuit 210. The communication processor 200 may allow a slot corresponding to a SIM corresponding to the identified SIM profile among the first slot 230 and the second slot 240 to be connected to the NFC circuit 210 via the switch 300.

In an embodiment, the database may include information related to a SIM profile in which at least one NFC App is installed. In an embodiment, information related to a SIM profile in which an NFC App is installed may be generated by mapping at least one of a name of the NFC App, a number of a SIM profile in which the NFC App is installed, and state information indicating whether the SIM profile in which the NFC App is installed is enabled or disabled. In an embodiment, the information related to the SIM profile in which the NFC App is installed may be generated by mapping a service provided by the NFC App as well as the at least one of the name of the NFC App, the number of the SIM profile in which the NFC App is installed, and the state information indicating whether the SIM profile in which the NFC App is installed is enabled or disabled.

Continuing to refer to FIG. 3, it may be assumed that an NFC App NFC_A is installed in the first SIM 231, an NFC App NFC_B and an NFC App NFC_C are installed in the second SIM 241, both the first SIM 231 and the second SIM 241 are enabled, and a SIM connected by default to the NFC circuit 210 is the first SIM 231. For example, a service provided by the NFC_A may be an identification card service, a service provided by the NFC_B may be a transportation ID service, and a service provided by the NFC_C may be a bank A App service associated with a bank A. In an embodiment, the name of the NFC App may be an ID of the NFC App (hereinafter, referred to as NFC App ID). In the disclosure, the NFC App ID has been described as an example of the name of the NFC App, but there is no limitation on a format of the NFC App ID, and it may be used as the NFC App ID as long as it is possible to distinguish between NFC Apps.

In an embodiment, the database may be generated as shown in Table 1 below.

TABLE 1
NFC App Database

| NFC Service | Profile Num | NFC App Name | Status |
|---|---|---|---|
| Identification Card | PSIM_1 | NFC_A | Enable |
| Transportation ID | PSIM_2 | NFC_B | Enable |
| A Bank Application | PSIM_2 | NFC_C | Enable |

Referring to Table 1, the NFC Service column may represent a service provided by an installed NFC App, the Profile Num column may represent the number of a SIM profile in which the NFC App is installed, the NFC APP Name column may represent a name of the NFC App, and the Status column may represent status information indicating whether the SIM profile in which the NFC App is installed is enabled or disabled.

When receiving the NFC App ID from the external electronic device via the NFC circuit 210, the communication processor 200 may identify a SIM profile in which an NFC App corresponding to the received NFC App ID is installed based on the database, and control the switch 300 so that a SIM corresponding to the SIM profile in which the NFC App is installed is connected to the NFC circuit 210 (for example, so that a slot corresponding to the SIM corresponding to the SIM profile in which the NFC App is installed is connected to the NFC circuit 210). For example, if the NFC App ID received from the external electronic device is NFC_B, the communication processor 200 may control the switch 300 so that the second SIM 241 other than the first SIM 231, which is a SIM connected to the NFC circuit 210 by default, is connected to the NFC circuit 210 (e.g., so that the second slot 240 corresponding to the second SIM 241 is connected to the NFC circuit 210). When identifying that an NFC communication corresponding to the NFC_B is terminated, the communication processor 200 may control the switch 300 to connect the first SIM 231 to the NFC circuit 210 again.

Although an example in which the switch 300 connects the NFC circuit 210 and one of the first slot 230 and the second slot 240 under the control of the communication processor 200 has been described with reference to FIG. 3, the electronic device 101 does not have the switch 300 separately, and the communication processor 200 may use a control signal, for example, for enabling a SIM profile corresponding to the first SIM 231 or a SIM profile corresponding to the second SIM 241 to connect a corresponding SIM and the NFC circuit 210. As another example, the electronic device 101 may use a control signal for disabling the SIM profile corresponding to the first SIM 231 or the SIM profile corresponding to the second SIM 241 to prevent a corresponding SIM and the NFC circuit 210 from being connected.

Although a case in which both the first SIM 231 and the second SIM 241 are enabled has been described as an example in FIG. 3, the disclosure is not limited in this regard. For example, only one of the first SIM 231 and the second SIM 241 may be enabled. When only the one of the first SIM 231 and the second SIM 241 is enabled, if an NFC App ID corresponding to a SIM (or a SIM profile) that is not enabled (or that is disabled) is received, the communication processor 200 may enable the corresponding SIM (or the corresponding SIM profile) and control the switch 300 so that the enabled SIM (or the enabled SIM profile) is connected to the NFC circuit 210. When identifying that an NFC communication corresponding to the enabled SIM (or the enabled SIM profile) is terminated, the communication processor 200 may disable the enabled SIM (or the enabled SIM profile) again.

A case in which the NFC App ID received from the external electronic device via the NFC circuit 210 is stored in the database has been described as an example with reference to FIG. 3. However, when receiving the NFC App ID from the external electronic device, the communication processor 200 may perform an operation as described in FIG. 3 only if the received NFC App ID is stored in the database.

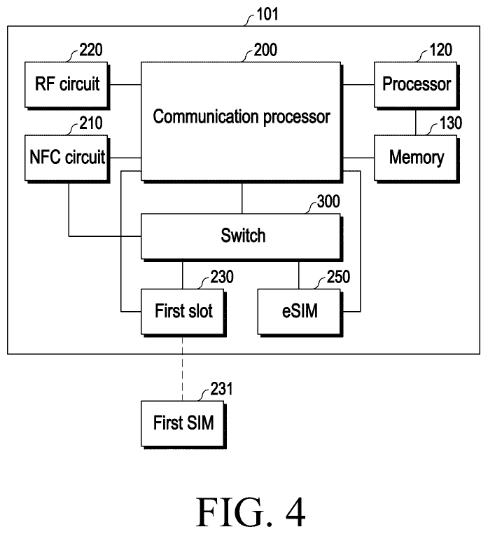

FIG. 4 is a block diagram schematically illustrating, an electronic device according to an embodiment.

Referring to FIG. 4, an electronic device 101 may include at least one of the processor 120, the communication processor 200, the NFC circuit 210, the RF circuit 220, the memory 130, the first slot 230, the eSIM 250, or the switch 300. A case illustrated in FIG. 4 may be a case in which the electronic device 101 uses the first SIM 231 and the eSIM 250, and the first SIM 231 may be and/or may include a pSIM (or an rSIM).

The electronic device 101 of FIG. 4 may include and/or may be similar in many respects to the electronic device 101 described above with reference to FIGS. 1A to 3, and may include additional features not mentioned above. Furthermore, the components of the electronic device 101 of FIG. 4 may include and/or may be similar in many respects to the respective components of the electronic device 101 described above with reference to FIGS. 1A to 3, and may include additional features not mentioned above. Consequently, repeated descriptions of the electronic device 101, and its components, described above with reference to FIGS. 1A to 3 may be omitted for the sake of brevity.

The communication processor 200 may support establishment of a communication channel in a band to be used for a wireless communication, and a network communication via the established communication channel. For example, the communication processor 200 may support at least one of a 2G network communication, a 3G network communication, a 4G network communication, or a 5G network communication.

The NFC circuit 210 may interact with an external electronic device (e.g., the electronic device 102 or the electronic device 104 of FIG. 1A) having an NFC function. The external electronic device may be and/or may include a POS device. The NFC circuit 210 may provide a wireless connection between the electronic device 101 and the external electronic device within a set radius (e.g., about four (4) cm). The NFC circuit 210 may operate in a card mode, and the card mode may be implemented similarly to or substantially the same as that described in FIG. 2, consequently, a repeated description thereof may be omitted for the sake of brevity.

The RF circuit 220 may include at least one of an RFIC, an RFFE module, or an antenna module. The RF circuit 220 may convert data (e.g., a baseband signal) outputted from the communication processor 200 into an RF signal and transmit the RF signal via the antenna module. The RF circuit 220 may convert an RF signal received via the antenna module (e.g., an antenna module 197 in FIG. 1A) into a baseband signal and transfer the baseband signal to the communication processor 200. The RF circuit 220 may process an RF signal or a baseband signal based on a communication scheme supported by the communication processor 200, and there is no limitation on a type of the RF circuit 220. The RF circuit 220 may be implemented similarly to or substantially the same as that described in FIG. 2, consequently, a repeated description thereof may be omitted for the sake of brevity.

As shown in FIG. 4, the processor 120 and the communication processor 200 may be implemented as separate hardware, but this is merely an example. In an embodiment, the processor 120 and the communication processor 200 may be implemented as separate hardware. Alternatively, the processor 120 and the communication processor 200 may be implemented on a single chip.

According to an embodiment, the communication processor 200 may perform an authenticating operation based on information stored in a SIM. In an embodiment, the information stored in the SIM may refer to a SIM profile. The SIM profile may refer a profile corresponding to (or stored in) the SIM or an eSIM.

The communication processor 200 may be connected to the first SIM 231 via the first slot 230. For example, the first SIM 231 may be connected to a stack (e.g., a protocol stack according to ISO/IEC 7816) of the communication processor 200. In an embodiment, the communication processor 200 may include two stacks. For example, the first slot 230 may accommodate the first SIM 231, which may be and/or may include a pSIM (or an rSIM), and the first slot 230 may include at least one terminal capable of transferring information from the first SIM 231 to the communication processor 200 if the first SIM 231 is accommodated (e.g., if the first SIM 231 is mounted).

The communication processor 200 may obtain information (e.g., a first SIM profile) stored in the first SIM 231 from the first SIM 231 accommodated in the first slot 230. For example, in at least one of the first SIM 231 or the second SIM 241, at least one of an ICCID, an IMSI, HPLMN-related information, or an MSISDN may be stored. The communication processor 200 may perform, via the RF circuit 220, an authenticating operation for a network communication that may correspond to the first SIM 231, based on the obtained information stored in the first SIM 231. If authentication is successful, the communication processor 200 may perform the network communication that may correspond to the first SIM 231 via the RF circuit 220. The communication processor 200 may perform an NFC communication with an external electronic device via the NFC circuit 210 based on the obtained information that is stored in the first SIM 231.

In an embodiment, the communication processor 200 may connect the NFC circuit 210 to one of the first slot 230 and the eSIM 250 via the switch 300. In an embodiment, when receiving an NFC App ID from an external electronic device (e.g., a POS device) via the NFC circuit 210, the communication processor 200 may identify, based on a database stored in the memory 130, a SIM profile in which an NFC App corresponding to the NFC App ID is installed, and perform an NFC communication with the external electronic device based on the identified SIM profile via the NFC circuit 210. The communication processor 200 may allow one of the first slot 230 and the eSIM 250 to be connected to the NFC circuit 210 via the switch 300, corresponding to the identified SIM profile. The database may be implemented similarly to or substantially the same as that described in FIG. 3, consequently, a repeated description thereof may be omitted for the sake of brevity.

Continuing to refer to FIG. 4, it may be assumed that an NFC App NFC_A is installed in the first SIM 231, an NFC App NFC_B, an NFC App NFC_C, and an NFC App NFC_D are installed in the eSIM 250, a SIM profile eSIM_1 of the first SIM 231 and the eSIM 250 is enabled, a SIM profile eSIM_2 of the eSIM 250 is disabled, and a SIM connected by default to the NFC circuit 210 is the first SIM 231. For example, a service provided by the NFC_A may be and/or may include an identification card service, a service provided by the NFC_B may be and/or may include a transportation ID service, a service provided by the NFC_C may be and/or may include a bank A App service associated with a bank A, and a service provided by the NFC_D may be and/or may include an own home key service. In an embodiment, the name of the NFC App may be an NFC App ID. In the disclosure, the NFC App ID has been described as an example of the name of the NFC App, but there is no limitation on a format of the NFC App ID, and the name of the NFC App may be used as the NFC App ID as long as it is possible to distinguish between NFC Apps.

In an embodiment, the database may be generated as shown in Table 2 below.

TABLE 2
NFC App Database

| NFC Service | Profile Num | NFC App Name | Status |
|---|---|---|---|
| Identification Card | PSIM_1 | NFC_A | Enable |
| Transportation ID | eSIM_1 | NFC_B | Enable |
| A Bank Application | eSIM_1 | NFC_C | Enable |
| Own Home Key | eSIM_2 | NFC_D | Enable |

Referring to Table 2, the NFC Service column may represent a service provided by an installed NFC App, the Profile Num column may represent the number of a SIM profile in which the NFC App is installed, the NFC APP name column may represent a name of the NFC App, and the Status column may represent status information indicating whether the SIM profile in which the NFC App is installed is enabled or disabled.

When receiving the NFC App ID from the external electronic device via the NFC circuit 210, the communication processor 200 may identify a SIM profile in which an NFC App corresponding to the received NFC App ID is installed based on the database, and control the switch 300 so that a SIM corresponding to the SIM profile in which the NFC App is installed is connected to the NFC circuit 210 (for example, so that a slot corresponding to the SIM corresponding to the SIM profile in which the NFC App is installed is connected to the NFC circuit 210). For example, if the NFC App ID received from the external electronic device is NFC_B, the communication processor 200 may control the switch 300 so that the eSIM 250 other than the first SIM 231, which is a SIM connected to the NFC circuit 210 by default, is connected to the NFC circuit 210. When identifying that an NFC communication corresponding to the NFC_B is terminated, the communication processor 200 may control the switch 300 to connect the first SIM 231 to the NFC circuit 210 again.

Although an example in which the SIM profile eSIM_1 of the first SIM 231 and the eSIM 250 is enabled and the SIM profile eSIM_2 of the eSIM 250 is disabled has been described with reference to FIG. 4, the disclosure is not limited in this regard. For example, only one of the SIM profiles of the first SIM 231 and the eSIM 250 may be enabled. When only the one of the SIM profiles of the first SIM 231 and the eSIM 250 is enabled, if an NFC App ID corresponding to a SIM (or SIM profile) that is not enabled (or that is disabled) is received, the communication processor 200 may enable the corresponding SIM (or SIM profile) and control the switch 300 so that the enabled SIM is connected to the NFC circuit 210.

When identifying that an NFC communication corresponding to the enabled SIM (or the SIM profile) is terminated, the communication processor 200 may disable the enabled SIM (or the SIM profile) again.

Although an example in which the switch 300 connects the NFC circuit 210 and one of the first slot 230 and the eSIM 250 under the control of the communication processor 200 has been described with reference to FIG. 4, the disclosure is not limited in the regard. For example, the electronic device 101 does not have the switch 300 separately, and the communication processor 200 may use a control signal for enabling a SIM profile corresponding to the first SIM 231 or a SIM profile corresponding to the eSIM 250 to connect a corresponding SIM and the NFC circuit 210. As another example, the electronic device 101 may use a control signal for disabling the SIM profile corresponding to the first SIM 231 or the SIM profile corresponding to the eSIM 250 to prevent a corresponding SIM and the NFC circuit 210 from being connected.

Although an example in which the NFC App ID is received from the external electronic device via the NFC circuit 210 is stored in the database has been described with reference to FIG. 4, the disclosure is not limited in this regard. For example, when receiving the NFC App ID from the external electronic device, the communication processor 200 may perform an operation as described in FIG. 4 only if the received NFC App ID is stored in the database.

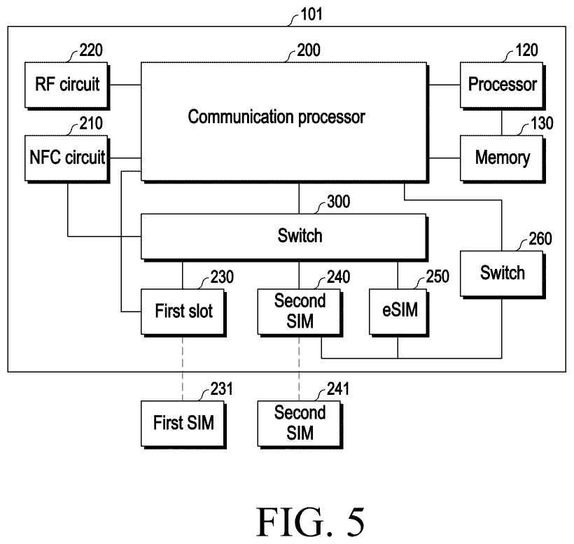

FIG. 5 is a block diagram schematically illustrating an electronic device, according to an embodiment.

Referring to FIG. 5, the electronic device 101 may include at least one of the processor 120, the communication processor 200, the NFC circuit 210, the RF circuit 220, the memory 130, the first slot 230, the second slot 240, the eSIM 250, the switch 260, or the switch 300.

The electronic device 101 of FIG. 5 may include and/or may be similar in many respects to the electronic device 101 described above with reference to FIGS. 1A to 4, and may include additional features not mentioned above. Furthermore, the components of the electronic device 101 of FIG. 5 may include and/or may be similar in many respects to the respective components of the electronic device 101 described above with reference to FIGS. 1A to 4, and may include additional features not mentioned above. Consequently, repeated descriptions of the electronic device 101, and its components, described above with reference to FIGS. 1A to 4 may be omitted for the sake of brevity.

As shown in FIG. 5, the electronic device 101 may use the first SIM 231, the second SIM 241, and the eSIM 250, and each of the first SIM 231 and the second SIM 241 may be and/or may include a pSIM (or an rSIM).

The communication processor 200 may support establishment of a communication channel in a band to be used for a wireless communication, and a network communication via the established communication channel. For example, the communication processor 200 may support at least one of a 2G network communication, a 3G network communication, a 4G network communication, or a 5G network communication.

The NFC circuit 210 may interact with an external electronic device (e.g., the electronic device 102 or the electronic device 104 of FIG. 1A) having an NFC function. The external electronic devices 102 and 104 may be and/or may include a POS device. The NFC circuit 210 may provide a wireless connection between the electronic device 101 and the external electronic device within a set radius (e.g., about four (4) cm). The NFC circuit 210 may operate in a card mode, and the card mode may be implemented similarly to and/or substantially the same as described with reference to FIG. 2, consequently, a repeated description thereof may be omitted for the sake of brevity.

The RF circuit 220 may include at least one of an RFIC, an RFFE module, or an antenna module. The RF circuit 220 may convert data (e.g., a baseband signal) outputted from the communication processor 200 into an RF signal and may transmit the RF signal via the antenna module. The RF circuit 220 may convert an RF signal received via the antenna module (e.g., the antenna module 197 of FIG. 1A) into a baseband signal and may transfer the baseband signal to the communication processor 200. The RF circuit 220 may process an RF signal and/or a baseband signal based on a communication scheme supported by the communication processor 200. The disclosure is not limited as to the type of the RF circuit 220. The RF circuit 220 may be implemented similarly to and/or substantially the same as that described with reference to FIG. 2, consequently, a repeated description thereof may be omitted for the sake of brevity.

Although FIG. 5 illustrates the processor 120 and the communication processor 200 implemented as separate hardware, this is merely an example and the disclosure is not limited in this regard. In an embodiment, the processor 120 and the communication processor 200 may be implemented as separate hardware. Alternatively, the processor 120 and the communication processor 200 may be implemented on a single chip.

According to an embodiment, the communication processor 200 may perform an authenticating operation based on information stored in a SIM. In an embodiment, the information stored in the SIM may refer to a SIM profile. The SIM profile may refer to a profile corresponding to (or stored in) the SIM or an eSIM.

The communication processor 200 may be connected to the first SIM 231 via the first slot 230. For example, the first SIM 231 may be connected to a stack (e.g., a protocol stack according to ISO/IEC 7816) of the communication processor 200. In an embodiment, the communication processor 200 may include two stacks. For example, the first slot 230 may accommodate the first SIM 231 which may be and/or may include a pSIM (or an rSIM), and the first slot 230 may include at least one terminal capable of transferring information from the first SIM 231 to the communication processor 200 if the first SIM 231 is accommodated (or if the first SIM 231 is mounted). The second slot 240 may accommodate the second SIM 241 that may be a pSIM (or an rSIM), and the second slot 240 may include at least one terminal capable of transferring information from the second SIM 241 to the communication processor 200 if the second SIM 241 is accommodated (e.g., if the second SIM 241 is mounted). A type of the first slot 230 may be the same as or different from a type of the second slot 240.

The communication processor 200 may obtain information (e.g., a first SIM profile) stored in the first SIM 231 from the first SIM 231 accommodated in the first slot 230. The communication processor 200 may perform, via the RF circuit 220, an authenticating operation for a network communication that may correspond to the first SIM 231, based on the obtained information stored in the first SIM 231. If authentication is successful, the communication processor 200 may perform the network communication that may correspond to the first SIM 231 via the RF circuit 220. The communication processor 200 may perform an NFC communication with an external electronic device via the NFC circuit 210 based on the obtained information that is stored in the first SIM 231.

According to an embodiment, at least one of the processor 120 or the communication processor 200 may control a state of the switch 260. The state of the switch 260 may be either a first state connecting the communication processor 200 and the second slot 240 or a second state connecting the communication processor 200 and the eSIM 250. In an embodiment, the state of the switch 260 may be controlled to be a third state in which the switch 260 is not connected to any of the second slot 240 or the eSIM 250. An operation of the processor 120 or the communication processor 200 to control the state of the switch 260 may be implemented similarly to and/or substantially the same as described with reference to FIG. 2, consequently, a repeated description thereof may be omitted for the sake of brevity.

In an embodiment, the communication processor 200 may connect the NFC circuit 210 to one of the first slot 230, the second slot 240, and the eSIM 250 via the switch 300. In an embodiment, when receiving an NFC App ID from an external electronic device (e.g., a POS device) via the NFC circuit 210, the communication processor 200 may identify, based on a database stored in the memory 130, a SIM profile in which an NFC App corresponding to the NFC App ID is installed, and perform an NFC communication with the external electronic device based on the identified SIM profile via the NFC circuit 210. The communication processor 200 may allow one of the first slot 230, the second slot 240, and the eSIM 250 to be connected to the NFC circuit 210 via the switch 300, corresponding to the identified SIM profile. The database may be implemented similarly to and/or substantially the same as described with reference to FIG. 3, consequently, a repeated description thereof may be omitted for the sake of brevity.

Continuing to refer to FIG. 5, it may be assumed that an NFC App NFC_A is installed in the first SIM 231, an NFC App NFC_B, an NFC App NFC_C, and an NFC App NFC_D are installed in the eSIM 250, the first SIM 231 is enabled, a SIM profile eSIM_1 of the eSIM 250 is enabled and/or disabled, a SIM profile eSIM_2 of the eSIM 250 is disabled, and a SIM connected by default to the NFC circuit 210 is the first SIM 231. For example, a service provided by the NFC_A may be an identification card service, a service provided by the NFC_B may be a transportation ID service, a service provided by the NFC_C may be a bank A App service associated with a bank A, and a service provided by the NFC_D may be an own home key service. In an embodiment, the name of the NFC App may be an NFC App ID. In the disclosure, the NFC App ID has been described as an example of the name of the NFC App, but there is no limitation on a format of the NFC App ID, and it may be used as the NFC App ID as long as it is possible to distinguish between NFC Apps.

In an embodiment case, the database may be generated as shown in Table 3 below.

TABLE 3
NFC App Database

| NFC Service | Profile Num | NFC App Name | Status |
|---|---|---|---|
| Identification Card | PSIM_1 | NFC_A | Enable |
| Transportation ID | eSIM_1 | NFC_B | Enable/Disable |
| A Bank Application | eSIM_1 | NFC_C | Enable/Disable |
| Own Home Key | eSIM_2 | NFC_D | Disable |

Referring to Table 3, the NFC Service column may represent a service provided by an installed NFC App, the Profile Num column may represent the number of a SIM profile in which the NFC App is installed, the NFC APP name column may represent a name of the NFC App, and the Status column may represent status information indicating whether the SIM profile in which the NFC App is installed is enabled or disabled.

When receiving the NFC App ID from the external electronic device via the NFC circuit 210, the communication processor 200 may identify a SIM profile in which an NFC App corresponding to the received NFC App ID is installed based on the database, and control the switch 300 so that a SIM corresponding to the SIM profile in which the NFC App is installed is connected to the NFC circuit 210 (e.g., so that a slot corresponding to the SIM corresponding to the SIM profile in which the NFC App is installed is connected to the NFC circuit 210). For example, if the NFC App ID received from the external electronic device is NFC_B, the communication processor 200 may control the switch 300 so that the eSIM 250 other than the first SIM 231, which is a SIM connected to the NFC circuit 210 by default, is connected to the NFC circuit 210. When identifying that an NFC communication corresponding to the NFC_B is terminated, the communication processor 200 may control the switch 300 to connect the first SIM 231 to the NFC circuit 210 again.

Although an example in which the switch 300 connects the NFC circuit 210 and one of the first slot 230, the second slot 240, and the eSIM 250 under the control of the communication processor 200 has been described with reference to FIG. 5, the electronic device 101 does not have the switch 300 separately, and the communication processor 200 may use a control signal, for example, for enabling a SIM profile corresponding to the first SIM 231, a SIM profile corresponding to the second SIM 241, or the eSIM 250 to connect a corresponding SIM and the NFC circuit 210. As another example, the electronic device 101 may use a control signal for disabling the SIM profile corresponding to the first SIM 231, or the SIM profile corresponding to the second SIM 241, or the eSIM 250 to prevent a corresponding SIM and the NFC circuit 210 from being connected.

Although a case in which the SIM profile eSIM_1 of the first SIM 231 and the eSIM 250 is enabled and/or disabled, and the SIM profile eSIM_2 of the eSIM 250 is disabled has been described with reference to FIG. 5, the disclosure is not limited in this regard. For example, only one of the SIM profiles of the first SIM 231, the second SIM 241, and the eSIM 250 may be enabled. When only the one of the SIM profiles of the first SIM 231, the second SIM 241, and the eSIM 250 is enabled, if an NFC App ID corresponding to a SIM (or a SIM profile) that is not enabled (or that is disabled) is received, the communication processor 200 may enable the corresponding SIM (or the corresponding SIM profile) and control the switch 300 so that the enabled SIM (or the enabled SIM profile) is connected to the NFC circuit 210.

When identifying that an NFC communication corresponding to the enabled SIM (or SIM profile) is terminated, the communication processor 200 may disable the enabled SIM (or SIM profile) again.

A case in which the NFC App ID received from the external electronic device via the NFC circuit 210 is stored in the database has been described as an example with reference to FIG. 5. However, when receiving the NFC App ID from the external electronic device, the communication processor 200 may perform an operation as described in FIG. 5 only if the received NFC App ID is stored in the database.

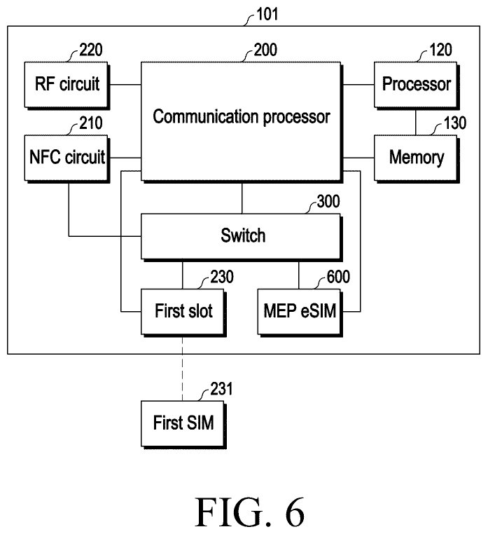

FIG. 6 is a block diagram schematically illustrating an electronic device, according to an embodiment.

Referring to FIG. 6, the electronic device 101 may include at least one of the processor 120, the communication processor 200, the NFC circuit 210, the RF circuit 220, the memory 130, the first slot 230, an MEP eSIM 600, or the switch 300.

The electronic device 101 of FIG. 6 may include and/or may be similar in many respects to the electronic device 101 described above with reference to FIGS. 1A to 5, and may include additional features not mentioned above. Furthermore, the components of the electronic device 101 of FIG. 6 may include and/or may be similar in many respects to the respective components of the electronic device 101 described above with reference to FIGS. 1A to 5, and may include additional features not mentioned above. Consequently, repeated descriptions of the electronic device 101, and its components, described above with reference to FIGS. 1A to 5 may be omitted for the sake of brevity.

As shown in FIG. 6, the electronic device 101 may use the first SIM 231 and the eSIM 250, and the first SIM 231 may be and/or may include a pSIM (or an rSIM).

The communication processor 200 may support establishment of a communication channel in a band to be used for a wireless communication, and a network communication via the established communication channel. For example, the communication processor 200 may support at least one of a 2G network communication, a 3G network communication, a 4G network communication, or a 5G network communication.

The NFC circuit 210 may interact with an external electronic device (e.g., the electronic device 102 or the electronic device 104 in FIG. 1A) having an NFC function. The external electronic devices 102 and 104 may be and/or may include a POS device. The NFC circuit 210 may provide a wireless connection between the electronic device 101 and the external electronic device within a set radius (e.g., about four (4) cm). The NFC circuit 210 may operate in a card mode, and the card mode may be implemented similarly to and/or substantially the same as described with reference to FIG. 2, consequently, a repeated description thereof may be omitted for the sake of brevity.

The RF circuit 220 may include at least one of an RFIC, an RFFE module, or an antenna module. The RF circuit 220 may convert data (e.g., a baseband signal) outputted from the communication processor 200 into an RF signal and may transmit the RF signal via the antenna module. The RF circuit 220 may convert an RF signal received via the antenna module (e.g., the antenna module 197 of FIG. 1A) into a baseband signal and may transfer the baseband signal to the communication processor 200. The RF circuit 220 may process an RF signal and/or a baseband signal based on a communication scheme supported by the communication processor 200. The disclosure is not limited as to the type of the RF circuit 220. The RF circuit 220 may be implemented similarly to and/or substantially the same as described with reference to FIG. 2, consequently, a repeated description thereof may be omitted for the sake of brevity.

Although FIG. 6 illustrates the processor 120 and the communication processor 200 implemented as separate hardware, this is merely an example and the disclosure is not limited in this regard. In an embodiment, the processor 120 and the communication processor 200 may be implemented as separate hardware. Alternatively, the processor 120 and the communication processor 200 may be implemented on a single chip.

According to an embodiment, the communication processor 200 may perform an authenticating operation based on information stored in a SIM. In an embodiment, the information stored in the SIM may refer a SIM profile. The SIM profile may refer a profile corresponding to (or stored in) the SIM or an eSIM.

The communication processor 200 may be connected to the first SIM 231 via the first slot 230. For example, the first SIM 231 may be connected to a stack (e.g., a protocol stack according to ISO/IEC 7816) of the communication processor 200. In an embodiment, the communication processor 200 may include two stacks. For example, the first slot 230 may accommodate the first SIM 231 may be and/or may include a pSIM (or an rSIM), and the first slot 230 may include at least one terminal capable of transferring information from the first SIM 231 to the communication processor 200 if the first SIM 231 is accommodated (e.g., if the first SIM 231 is mounted).

The communication processor 200 may obtain information (e.g., a first SIM profile) stored in the first SIM 231 from the first SIM 231 accommodated in the first slot 230. For example, in at least one of the first SIM 231 or the second SIM 241, at least one of an ICCID, an IMSI, HPLMN-related information, or an MSISDN may be stored. The communication processor 200 may perform, via the RF circuit 220, an authenticating operation for a network communication that may correspond to the first SIM 231, based on the obtained information stored in the first SIM 231. If authentication is successful, the communication processor 200 may perform the network communication that may correspond to the first SIM 231 via the RF circuit 220. The communication processor 200 may perform an NFC communication with an external electronic device via the NFC circuit 210 based on the obtained information that is stored in the first SIM 231.

In an embodiment, the communication processor 200 may connect the NFC circuit 210 to one of the first slot 230 and the MEP eSIM 600 via the switch 300. In an embodiment, when receiving an NFC App ID from an external electronic device (e.g., a POS device) via the NFC circuit 210, the communication processor 200 may identify, based on a database stored in the memory 130, a SIM profile in which an NFC App corresponding to the NFC App ID is installed, and perform an NFC communication with the external electronic device based on the identified SIM profile via the NFC circuit 210. The communication processor 200 may allow one of the first slot 230 and the MEP eSIM 600 to be connected to the NFC circuit 210 via the switch 300, corresponding to the identified SIM profile. The database may be implemented similarly to and/or substantially the same as described with reference to FIG. 3, consequently, a repeated description thereof may be omitted for the sake of brevity.

Continuing to refer to FIG. 6, it may be assumed that an NFC App NFC_A is installed in the first SIM 231, an NFC App NFC_B, an NFC App NFC_C, and an NFC App NFC_D are installed in the MEP eSIM 600, the first SIM 231 is enabled and/or disabled, a SIM profile eSIM_1 of the MEP eSIM 600 is enabled, a SIM profile eSIM_2 of the MEP eSIM 600 is enabled and/or disabled, and a SIM connected by default to the NFC circuit 210 is the first SIM 231. For example, a service provided by the NFC_A may be an identification card service, a service provided by the NFC_B may be a transportation ID service, a service provided by the NFC_C may be a bank A App service associated with a bank A, and a service provided by the NFC_D may be an own home key service. In an embodiment, the name of the NFC App may be an NFC App ID. In the disclosure, the NFC App ID has been described as an example of the name of the NFC App, but there is no limitation on a format of the NFC App ID, and it may be used as the NFC App ID as long as it is possible to distinguish between NFC Apps.

In an embodiment, the database may be generated as shown in Table 4 below.

TABLE 4
SIM Profile Database

| NFC Service | Profile Num | NFC App Name | Status |
|---|---|---|---|
| Identification Card | PSIM_1 | NFC_A | Enable/Disable |
| Transportation ID | eSIM_1 | NFC_B | Enable |
| A Bank Application | eSIM_1 | NFC_C | Enable |
| Own Home Key | eSIM_2 | NFC_D | Enable/Disable |

Referring to Table 4, the NFC Service column may represent a service provided by an installed NFC App, the Profile Num column may represent the number of a SIM profile in which the NFC App is installed, the NFC APP name column may represent a name of the NFC App, and the Status column may represent status information indicating whether the SIM profile in which the NFC App is installed is enabled or disabled.

When receiving the NFC App ID from the external electronic device via the NFC circuit 210, the communication processor 200 may identify a SIM profile in which an NFC App corresponding to the received NFC App ID is installed based on the database, and control the switch 300 so that a SIM corresponding to the SIM profile in which the NFC App is installed is connected to the NFC circuit 210 (for example, so that a slot corresponding to the SIM corresponding to the SIM profile in which the NFC App is installed is connected to the NFC circuit 210). For example, if the NFC App ID received from the external electronic device is NFC_B, the communication processor 200 may control the switch 300 so that the MEP eSIM 600 other than the first SIM 231, which is a SIM connected to the NFC circuit 210 by default, is connected to the NFC circuit 210. When identifying that an NFC communication corresponding to the NFC_B is terminated, the communication processor 200 may control the switch 300 to connect the first SIM 231 to the NFC circuit 210 again.

In an embodiment, if the first SIM 231 is disabled, two of SIM profiles of the MEP eSIM 600 are enabled, and an NFC App (e.g., an NFC App corresponding to the received NFC App ID) that the electronic device 101 intends to use is installed in a disabled SIM profile, the communication processor 200 may disable one of the enabled SIM profiles, and enable a SIM profile corresponding to the NFC App that the electronic device 101 intends to use. The communication processor 200 may disable a SIM profile that is not in a call/data connected state among the enabled SIM profiles, and enable the SIM profile corresponding to the NFC App that the electronic device 101 intends to use. When identifying that the NFC communication corresponding to the NFC App is terminated, the communication processor 200 may enable the SIM profile disabled by the communication processor 200 again, and disable the SIM profile corresponding to the NFC App. In an embodiment, if there is no limitation on the number of SIM profiles enabled in the MEP eSIM 600, the communication processor 200 may not perform the operation of enabling the SIM profile disabled by the communication processor 200 again, and disabling the SIM profile corresponding to the NFC App. For example, in an embodiment, if there is no limitation on the number of SIM profiles enabled in the MEP eSIM 600, the communication processor 200 may enable the SIM profile corresponding to the NFC App that the electronic device 101 intends to use without disabling one of the enabled SIM profiles. In this case, the communication processor 200 may not need to perform the operation of enabling the SIM profile disabled by the communication processor 200 again, and disabling the SIM profile corresponding to the NFC App.

Although a case in which the first SIM 231 is enabled and/or disabled, the SIM profile eSIM_1 of the MEP eSIM 600 is enabled and the SIM profile eSIM_2 of the MEP eSIM 600 is enabled and/or disabled has been described with reference to FIG. 6, the disclosure is not limited in this regard. For example, only one of the SIM profiles of the first SIM 231 and the MEP eSIM 600 may be enabled. When only the one of the SIM profiles of the first SIM 231 and the MEP eSIM 600 is enabled, if an NFC App ID corresponding to a SIM (or a SIM profile) that is not enabled (or that is disabled) is received, the communication processor 200 may enable the corresponding SIM (or SIM profile) and control the switch 300 so that the enabled SIM is connected to the NFC circuit 210.

When identifying that an NFC communication corresponding to the enabled SIM (or SIM profile) is terminated, the communication processor 200 may disable the enabled SIM (or SIM profile) again.

Although a case in which the switch 300 connects the NFC circuit 210 and one of the first slot 230 and the MEP eSIM 600 under the control of the communication processor 200 has been described as an example with reference to FIG. 6, the electronic device 101 does not have the switch 300 separately, and the communication processor 200 may use a control signal for enabling a SIM profile corresponding to the first SIM 231 or a SIM profile corresponding to the MEP eSIM 600 to connect a corresponding SIM and the NFC circuit 210, or may use a control signal for disabling the SIM profile corresponding to the first SIM 231 or the SIM profile corresponding to the MEP eSIM 600 to prevent a corresponding SIM and the NFC circuit 210 from being connected.

A case in which the NFC App ID received from the external electronic device via the NFC circuit 210 is stored in the database has been described as an example with reference to FIG. 6. However, when receiving the NFC App ID from the external electronic device, the communication processor 200 may perform an operation as described with reference to FIG. 6 only if the received NFC App ID is stored in the database.

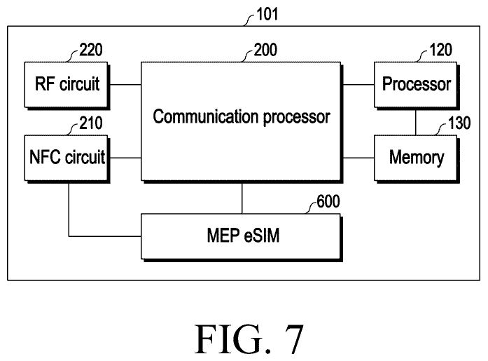

FIG. 7 is a block diagram schematically illustrating an electronic device, according to an embodiment.

Referring to FIG. 7, the electronic device 101 may include at least one of the processor 120, the communication processor 200, the NFC circuit 210, the RF circuit 220, the memory 130, or the MEP eSIM 600.

The electronic device 101 of FIG. 7 may include and/or may be similar in many respects to the electronic device 101 described above with reference to FIGS. 1A to 7, and may include additional features not mentioned above. Furthermore, the components of the electronic device 101 of FIG. 7 may include and/or may be similar in many respects to the respective components of the electronic device 101 described above with reference to FIGS. 1A to 7, and may include additional features not mentioned above. Consequently, repeated descriptions of the electronic device 101, and its components, described above with reference to FIGS. 1A to 7 may be omitted for the sake of brevity.

As shown in FIG. 7 the electronic device 101 may use the MEP eSIM 600.

The communication processor 200 may support establishment of a communication channel in a band to be used for a wireless communication, and a network communication via the established communication channel. For example, the communication processor 200 may support at least one of a 2G network communication, a 3G network communication, a 4G network communication, or a 5G network communication.

The NFC circuit 210 may interact with an external electronic device (e.g., the electronic device 102 or the electronic device 104 of FIG. 1A) having an NFC function. The external electronic devices 102 and 104 may be and/or may include a POS device. The NFC circuit 210 may provide a wireless connection between the electronic device 101 and the external electronic device within a set radius (e.g., about four (4) cm). The NFC circuit 210 may operate in a card mode, and the card mode may be implemented similarly to and/or substantially the same as described with reference to FIG. 2, consequently, a repeated description thereof may be omitted for the sake of brevity.

The RF circuit 220 may include at least one of an RFIC, an RFFE module, or an antenna module. The RF circuit 220 may convert data (e.g., a baseband signal) outputted from the communication processor 200 into an RF signal and may transmit the RF signal via the antenna module. The RF circuit 220 may convert an RF signal received via the antenna module (e.g., the antenna module 197 of FIG. 1A) into a baseband signal and transfer the baseband signal to the communication processor 200. The RF circuit 220 may process an RF signal and/or a baseband signal based on a communication scheme supported by the communication processor 200. The disclosure is not limited as to the type of the RF circuit 220. The RF circuit 220 may be implemented similarly to and/or substantially the same as that described with reference to FIG. 2, consequently, a repeated description thereof may be omitted for the sake of brevity.

Although FIG. 7 illustrates the processor 120 and the communication processor 200 implemented as separate hardware, this is merely an example and the disclosure is not limited in this regard. In an embodiment, the processor 120 and the communication processor 200 may be implemented as separate hardware. Alternatively, the processor 120 and the communication processor 200 may be implemented on a single chip.

According to an embodiment, the communication processor 200 may perform an authenticating operation based on information stored in a SIM. In an embodiment, the information stored in the SIM may refer to a SIM profile. The SIM profile may refer to a profile corresponding to (or stored in) the SIM or an eSIM.

The communication processor 200 may obtain information (e.g., a SIM profile) stored in the MEP eSIM 600. The communication processor 200 may perform, via the RF circuit 220, an authenticating operation for a network communication that may correspond to the MEP eSIM 600, based on the obtained information stored in the MEP eSIM 600. If authentication is successful, the communication processor 200 may perform the network communication that may correspond to the MEP eSIM 600 via the RF circuit 220. The communication processor 200 may perform an NFC communication with an external electronic device via the NFC circuit 210 based on the obtained information that is stored in the MEP eSIM 600.

In an embodiment, when receiving an NFC App ID from an external electronic device (e.g., a POS device) via the NFC circuit 210, the communication processor 200 may identify, based on a database stored in the memory 130, a SIM profile in which an NFC App corresponding to the NFC App ID is installed, and perform an NFC communication with the external electronic device based on the identified SIM profile via the NFC circuit 210. The communication processor 200 may allow a port of the MEP eSIM 600 to be connected to the NFC circuit 210 corresponding to the identified SIM profile. The database may be implemented similarly to and/or substantially the same as described with reference to FIG. 3, consequently, a repeated description thereof may be omitted for the sake of brevity.

Continuing to refer to FIG. 7, it may be assumed that an NFC App NFC_A, an NFC App NFC_B, an NFC App NFC_C, an NFC App NFC_D, and an NFC App NFC_Z are installed at the MEP eSIM 600, a SIM profile 1 and a SIM profile 2 of the MEP eSIM 600 are enabled, a SIM profile 3 of the MEP eSIM 600 is disabled, and a SIM profile connected by default to the NFC circuit 210 is the SIM profile 1. For example, a service provided by the NFC_A may be and/or may include an identification card service, a service provided by the NFC_B may be and/or may include a transportation ID service, a service provided by the NFC_C may be and/or may include a bank A App service associated with a bank A, a service provided by the NFC_D may be and/or may include an own home key service, and a service provided by the NFC_Z may be and/or may include a pass service of a park B (B Park Pass service). In an embodiment, the name of the NFC App may be an NFC App ID. In the disclosure, the NFC App ID has been described as an example of the name of the NFC App, but there is no limitation on a format of the NFC App ID, and it may be used as the NFC App ID as long as it is possible to distinguish between NFC Apps.

In an embodiment, the database may be generated as shown in Table 5 below.

TABLE 5
NFC App Database

| NFC Service | Profile Num | NFC App Name | Status |
|---|---|---|---|
| Identification Card | 1 | NFC_A | Enable |
| Transportation ID | 2 | NFC_B | Enable |
| A Bank Application | 2 | NFC_C | Enable |
| Own Home Key | 3 | NFC_D | Disable |
| B Park Pass | — | NFC_Z | Delete |

Referring Table 5, the NFC Service column may represent a service provided by an installed NFC App, the Profile Num column may represent the number of a SIM profile in which the NFC App is installed, the NFC APP name column may represent a name of the NFC App, and the Status column may represent status information indicating whether the SIM profile in which the NFC App is installed is enabled or disabled.

When receiving the NFC App ID from the external electronic device via the NFC circuit 210, the communication processor 200 may identify a SIM profile in which an NFC App corresponding to the received NFC App ID is installed based on the database, and control the NFC circuit 210 and the MEP eSIM 600 so that a SIM corresponding to the SIM profile in which the NFC App is installed is connected to the NFC circuit 210 (for example, so that a port corresponding to the SIM corresponding to the SIM profile in which the NFC App is installed is connected to the NFC circuit 210). For example, if the NFC App ID received from the external electronic device is NFC_B, the communication processor 200 may control the SIM profile 2 other than the SIM profile 1, which is a SIM profile connected to the NFC circuit 210 by default, to be connected to the NFC circuit 210.

In FIG. 7, only the MEP eSIM 600 is used, so the electronic device 101 may not need to include the switch 300 as described with reference to FIGS. 3 to 6. In a case of the MEP eSIM 600, a relatively large number of SIM profiles may be installed therein, and at least one NFC App may be installed for each corresponding SIM profile. Thus, an NFC communication may be performed by designating a port of a SIM profile required for the NFC communication among enabled SIM profiles using an interface shown in Table 6 below.

TABLE 6
SIM Profile Interface

| b8 | b7 | b6 | b5 | b4 | b3 | b2 | b1 | Meaning |
|---|---|---|---|---|---|---|---|---|
| 0 | 0 | 0 | 0 | 0 | 0 | 0 | 0 | Select LSI - Lc and Le not |
| | | | | | | | | present (see note 2) |
| 0 | 0 | 0 | 0 | 0 | 0 | 0 | 1 | Reset LSE - Lc not present, |
| | | | | | | | | Le present and set to ‘00’ |
| 0 | 0 | 0 | 0 | 0 | 0 | 1 | 0 | Assign SWP - Lc not present, |
| | | | | | | | | Le present and set to ‘00’ |
| 0 | 0 | 0 | 0 | 0 | 0 | 1 | 1 | Retrieve SWP - P2 set to |
| | | | | | | | | ‘00’, Lc not present, Le |
| | | | | | | | | present and set to ‘00’ |
| 0 | 0 | 0 | 0 | 0 | 1 | 0 | 0 | Configure LSIs - P2 set to |
| | | | | | | | | ‘00’, Lc and data present, |
| | | | | | | | | Le present and set to ‘00’ |

Note 1:
All other values are RFU.
Note 2:
If the NAD byte is used to select the LSI, this command shall not be used by the terminal.

Referring to Table 6, an interface related to a single wire protocol (SWP) is shown that may conform with a telecommunications standard, such as, but not limited to, European Telecommunications Standards Institute (ESTI) 102.221 REL-17. As shown in Table 6, if a signal with a value of ‘00000010’ is transferred, it may indicate the allocating (or assigning) of the SWP, and if a signal with a value of ‘00000011’ is transferred, it may indicate the recovering (or retrieving) of the SWP.

If an NFC App (e.g., an NFC App corresponding to the received NFC App ID) that the electronic device 101 intends to use is installed in a disabled SIM profile, the communication processor 200 may disable one of the enabled SIM profiles, and enable a SIM profile corresponding to the NFC App that the electronic device 101 intends to use. The communication processor 200 may disable a SIM profile that is not in a call/data connected state among the enabled SIM profiles, and enable the SIM profile corresponding to the NFC App that the electronic device 101 intends to use. When identifying that the NFC communication corresponding to the NFC App is terminated, the communication processor 200 may enable the SIM profile disabled by the communication processor 200 again, and disable the SIM profile corresponding to the NFC App. In an embodiment, if there is no limitation on the number of SIM profiles enabled in the MEP eSIM 600, the communication processor 200 may not perform the operation of enabling the SIM profile disabled by the communication processor 200 again, and disabling the SIM profile corresponding to the NFC App. For example, in an embodiment, if there is no limitation on the number of SIM profiles enabled in the MEP eSIM 600, the communication processor 200 may enable the SIM profile corresponding to the NFC App that the electronic device 101 intends to use without disabling one of the enabled SIM profiles. In such an example, the communication processor 200 may not need to perform the operation of enabling the SIM profile disabled by the communication processor 200 again, and disabling the SIM profile corresponding to the NFC App.

Although an example in which the SIM profile 1 and the SIM profile 2 of the MEP eSIM 600 are enabled and the SIM profile 3 of the MEP eSIM 600 is disabled has been described with reference to FIG. 7, the disclosure is not limited in this regard. For example, only one of the SIM profiles of the MEP eSIM 600 may be enabled. When only the one of the SIM profiles of the MEP eSIM 600 is enabled, if an NFC App ID corresponding to a SIM profile that is not enabled (or that is disabled) is received, the communication processor 200 may enable the corresponding SIM profile and control the enabled SIM to be connected to the NFC circuit 210.

When identifying that an NFC communication corresponding to the enabled SIM profile is terminated, the communication processor 200 may disable the enabled SIM profile again.

A case in which the NFC App ID received from the external electronic device via the NFC circuit 210 is stored in the database has been described as an example with reference to FIG. 7. However, when receiving the NFC App ID from the external electronic device, the communication processor 200 may perform an operation as described in FIG. 7 only if the received NFC App ID is stored in the database.

According to an embodiment of the disclosure, an electronic device 101 may include an NFC circuit 210, at least one processor (e.g., processor 120 and/or communication processor 200) operatively connected to the NFC circuit 210, and a memory 130 storing instructions.

According to an embodiment of the disclosure, the instructions stored in the memory 130, when executed by the at least one processor, may cause the electronic device 101 to receive, via the NFC circuit 210, an NFC application ID from an external electronic device (e.g., electronic device 102 or electronic device 104).

According to an embodiment of the disclosure, the instructions stored in the memory 130, when executed by the at least one processor, may cause the electronic device 101 to identify a SIM profile, from among a plurality of SIM profiles, that corresponds to the NFC application ID.

According to an embodiment of the disclosure, the instructions stored in the memory 130, when executed by the at least one processor, may cause the electronic device 101 to perform, via the NFC circuit 210, an NFC communication with the external electronic device based on the identified SIM profile.

According to an embodiment of the disclosure, the instructions stored in the memory 130, when executed by the at least one processor, may cause the electronic device 101 to identify the SIM profile, from among the plurality of SIM profiles, that corresponds to the NFC application ID based on a database including information related to at least one SIM profile in which at least one NFC application is installed.

According to an embodiment of the disclosure, an NFC application corresponding to the NFC application ID is installed in the identified SIM profile.

According to an embodiment of the disclosure, the instructions stored in the memory 130, when executed by the at least one processor, may cause the electronic device 101 to identify whether the identified SIM profile is enabled.

According to an embodiment of the disclosure, the instructions stored in the memory 130, when executed by the at least one processor, may cause the electronic device 101 to, based on identifying that the identified SIM profile is disabled, control to enable the identified SIM profile and perform, via the NFC circuit 210, the NFC communication with the external electronic device by enabling the identified SIM profile.

According to an embodiment of the disclosure, the instructions stored in the memory 130, when executed by the at least one processor, may cause the electronic device 101 to, after the NFC communication is performed, control to disable the identified SIM profile.

According to an embodiment of the disclosure, the instructions stored in the memory 130, when executed by the at least one processor, may cause the electronic device 101 to identify the SIM profile, from among the plurality of SIM profiles, that corresponds to the NFC application ID based on a database including information related to at least one SIM profile in which at least one NFC application is installed.

According to an embodiment of the disclosure, an NFC application corresponding to the NFC application ID is installed in the identified SIM profile.

According to an embodiment of the disclosure, the instructions stored in the memory 130, when executed by the at least one processor, may cause the electronic device 101 to, based on identifying that the identified SIM profile is disabled, control to enable the identified SIM profile.

According to an embodiment of the disclosure, the instructions stored in the memory 130, when executed by the at least one processor, may cause the electronic device 101 to perform, via the NFC circuit 210, the NFC communication with the external electronic device by enabling the identified SIM profile.

According to an embodiment of the disclosure, the electronic device 101 may further include a switch 300 operatively connected to the at least one processor.

According to an embodiment of the disclosure, the switch 300 may be configured to connect the NFC circuit 210 to one of at least two among a first SIM 231, a second SIM 241, or an eSIM 250.

According to an embodiment of the disclosure, the instructions stored in the memory 130, when executed by the at least one processor, may cause the electronic device 101 to identify whether the identified SIM profile is enabled.

According to an embodiment of the disclosure, the instructions stored in the memory 130, when executed by the at least one processor, may cause the electronic device 101 to, based on identifying that the identified SIM profile is enabled, identify whether a SIM corresponding to the identified SIM profile is connected to the NFC circuit 210 via the switch 300.

According to an embodiment of the disclosure, the instructions stored in the memory 130, when executed by the at least one processor, may cause the electronic device 101 to, based on identifying that the SIM corresponding to the identified SIM profile is connected to the NFC circuit 210 via the switch 300, perform, via the NFC circuit 210, the NFC communication with the external electronic device based on the identified SIM profile.

According to an embodiment of the disclosure, the instructions stored in the memory 130, when executed by the at least one processor, may cause the electronic device 101 to, based on identifying that the SIM corresponding to the identified SIM profile is not connected to the NFC circuit 210 via the switch 300, connect the SIM corresponding to the identified SIM profile to the NFC circuit 210 via the switch 300.

According to an embodiment of the disclosure, the instructions stored in the memory 130, when executed by the at least one processor, may cause the electronic device 101 to perform, via the NFC circuit 210, the NFC communication with the external electronic device based on the identified SIM profile.

According to an embodiment of the disclosure, the instructions stored in the memory 130, when executed by the at least one processor, may cause the electronic device 101 to, based on identifying that the identified SIM profile is not enabled, enable the identified SIM profile.

According to an embodiment of the disclosure, the instructions stored in the memory 130, when executed by the at least one processor, may cause the electronic device 101 to identify whether a SIM corresponding to the identified SIM profile is connected to the NFC circuit 210 via the switch 300.

According to an embodiment of the disclosure, the instructions stored in the memory 130, when executed by the at least one processor, may cause the electronic device 101 to, based on identifying that the SIM corresponding to the identified SIM profile is connected to the NFC circuit 210 via the switch 300, perform, via the NFC circuit 210, the NFC communication with the external electronic device based on the identified SIM profile.

According to an embodiment of the disclosure, the instructions stored in the memory 130, when executed by the at least one processor, may cause the electronic device 101 to, based on identifying that the SIM corresponding to the identified SIM profile is not connected to the NFC circuit 210 via the switch 300, connect the SIM corresponding to the identified SIM profile to the NFC circuit 210 via the switch 300.

According to an embodiment of the disclosure, the instructions stored in the memory 130, when executed by the at least one processor, may cause the electronic device 101 to perform, via the NFC circuit 210, the NFC communication with the external electronic device based on the identified SIM profile.

According to an embodiment of the disclosure, the identified SIM profile may be included in a MEP eSIM 600 including at least two SIM profiles.

According to an embodiment of the disclosure, a port may be allocated to each of the at least two SIM profiles.

According to an embodiment of the disclosure, the instructions stored in the memory 130, when executed by the at least one processor, may cause the electronic device 101 to identify whether a port corresponding to the identified SIM profile is a port connected to the NFC circuit 210.

According to an embodiment of the disclosure, the instructions stored in the memory 130, when executed by the at least one processor, may cause the electronic device 101 to, based on identifying that the port corresponding to the identified SIM profile is the port connected to the NFC circuit 210, perform, via the NFC circuit 210, the NFC communication with the external electronic device based on the identified SIM profile.

According to an embodiment of the disclosure, the instructions stored in the memory 130, when executed by the at least one processor, may cause the electronic device 101 to, based on identifying that the port corresponding to the identified SIM profile is not the port connected to the NFC circuit 210, identify whether the identified SIM profile is enabled.

According to an embodiment of the disclosure, the instructions stored in the memory 130, when executed by the at least one processor, may cause the electronic device 101 to, based on identifying that the identified SIM profile is enabled, change the port connected to the NFC circuit 210 to a port corresponding to the identified SIM profile.

According to an embodiment of the disclosure, the instructions stored in the memory 130, when executed by the at least one processor, may cause the electronic device to perform, via the NFC circuit 210, the NFC communication with the external electronic device based on the identified SIM profile.

According to an embodiment of the disclosure, the instructions stored in the memory 130, when executed by the at least one processor, may cause the electronic device 101 to, based on identifying that the identified SIM profile is not enabled, enable the identified SIM profile.

According to an embodiment of the disclosure, the instructions stored in the memory 130, when executed by the at least one processor, may cause the electronic device 101 to change the port connected to the NFC circuit 210 to the port corresponding to the identified SIM profile.

According to an embodiment of the disclosure, the instructions stored in the memory 130, when executed by the at least one processor, may cause the electronic device 101 to perform, via the NFC circuit 210, the NFC communication with the external electronic device based on the identified SIM profile.

According to an embodiment of the disclosure, the instructions stored in the memory 130, when executed by the at least one processor, may cause the electronic device 101 to, based on identifying termination of the NFC communication, change the port connected to the NFC circuit 210 from the port corresponding to the identified SIM profile to a port that may have been connected to the NFC circuit 210 before the port corresponding to the identified SIM profile.

According to an embodiment of the disclosure, the database may be generated by mapping, to each of the at least one NFC application, a name of an NFC application, a number of a SIM profile in which the NFC application is installed, and state information indicating whether the SIM profile in which the NFC application is installed is enabled or disabled.

According to an embodiment of the disclosure, the database may be generated by mapping a service provided by the NFC application to each of the at least one NFC application.

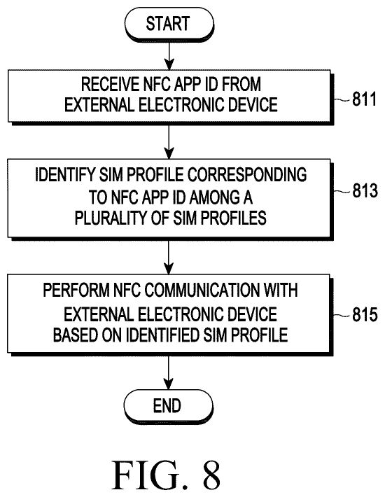

FIG. 8 is a flowchart depicting an example of an operating method of an electronic device, according to an embodiment.

Referring to FIG. 8, the electronic device (e.g., the electronic device 101 of FIGS. 1A to 7) and/or at least one processor (e.g., the processor 120 and/or the communication processor 200 of FIGS. 1A to 7) may receive an NFC App ID from an external electronic device (e.g., the electronic device 102 or the electronic device 104 of FIG. 1A) via an NFC circuit (e.g., the NFC circuit 210 of FIGS. 2 to 7) in operation 811. In an embodiment, the external electronic device may be and/or may include a POS device.

The electronic device, which receives the NFC App ID from the external electronic device, may identify a SIM profile corresponding to the NFC App ID from among a plurality of SIM profiles in operation 813.

In an embodiment, the identified SIM profile may be a SIM profile in which an NFC App is installed. Information related to the SIM profile in which the NFC App is installed may be generated by mapping at least one of a name of the NFC App, a number of the SIM profile in which the NFC App is installed, or state information indicating whether the SIM profile in which the NFC application is installed is enabled or disabled. In an embodiment, the information related to the SIM profile in which the NFC App is installed may be generated by mapping a service provided by the NFC App as well as the at least one of the name of the NFC App, the number of the SIM profile in which the NFC App is installed, or the state information indicating whether the SIM profile in which the NFC application is installed is enabled or disabled. A database including information related to a SIM profile in which at least one NFC App is installed may be implemented similarly to and/or substantially the same as described with reference to FIGS. 3 to 7, consequently, a repeated description thereof may be omitted for the sake of brevity.

The electronic device, which identifies the SIM profile corresponding to the NFC App ID, may perform an NFC communication with the external electronic device based on the identified SIM profile via the NFC circuit in operation 815. An operation of performing the NFC communication with the external electronic device based on the identified SIM profile via the NFC circuit may be implemented similarly to and/or substantially the same as described with reference to FIGS. 3 to 7, and may be summarized as follows.

In an embodiment, the electronic device may identify whether the identified SIM profile is enabled, and perform the NFC communication with the external electronic device based on the identified SIM profile via the NFC circuit, based on identifying that the identified SIM profile is enabled in operation 815.

In an embodiment, the electronic device may enable the identified SIM profile based on identifying that the identified SIM profile is disabled, and perform the NFC communication with the external electronic device based on the identified SIM profile that is enabled via the NFC circuit in operation 815.

In an embodiment, the electronic device may further include a switch (e.g., the switch 300 of FIGS. 3 to 6) that may connect one of at least two among a first SIM (e.g., the first SIM 111 of FIG. 1B, or the first SIM 231 of FIGS. 2 to 6), a second SIM (e.g., the second SIM 112 of FIG. 1B, or the second SIM 241 of FIGS. 2, 3, and 5), or an eSIM (e.g., the eSIM 196 of FIG. 1B, or the eSIM 250 of FIGS. 2, 4, and 5) to the NFC circuit.

In an embodiment, in operation 815, the electronic device may identify whether the identified SIM profile is enabled, identify whether a SIM corresponding to the identified SIM profile is connected to the NFC circuit via the switch based on identifying that the identified SIM profile is enabled, and perform, via the NFC circuit based on the identified SIM profile, an NFC communication with the external electronic device based on identifying that the SIM corresponding to the identified SIM profile is connected to the NFC circuit via the switch.

In an embodiment, in operation 815, the electronic device may connect the SIM corresponding to the identified SIM profile and the NFC circuit via the switch based on identifying that the SIM corresponding to the identified SIM profile is not connected to the NFC circuit via the switch, and perform, via the NFC circuit, an NFC communication with the external electronic device based on the identified SIM profile.

In an embodiment, in operation 815, the electronic device may enable the identified SIM profile based on identifying that the identified SIM profile is not enabled, identify whether the SIM corresponding to the identified SIM profile is connected to the NFC circuit via the switch, and perform, via the NFC circuit, an NFC communication with the external electronic device based on the identified SIM profile based on identifying that the SIM corresponding to the identified SIM profile is connected to the NFC circuit via the switch.

In an embodiment, in operation 815, the electronic device may connect the SIM corresponding to the identified SIM profile and the NFC circuit via the switch based on identifying that the SIM corresponding to the identified SIM profile is not connected to the NFC circuit via the switch, and perform, via the NFC circuit, an NFC communication with the external electronic device based on the identified SIM profile.

In an embodiment, the identified SIM profile may be included in an MEP eSIM (e.g., the MEP eSIM 600 of FIGS. 6 and 7) including at least two SIM profiles, and a port may be allocated to each of the at least two SIM profiles.

In an embodiment, in operation 815, the electronic device may identify whether a port corresponding to the identified SIM profile is a port connected to the NFC circuit, and perform, via the NFC circuit based on the identified SIM profile, an NFC communication with the external electronic device based on identifying that the port corresponding to the identified SIM profile is the port connected to the NFC circuit.

In an embodiment, in operation 815, the electronic device may identify whether the identified SIM profile is enabled based on identifying that the port corresponding to the identified SIM profile is not the port connected to the NFC circuit, change a port connected to the NFC circuit to the port corresponding to the identified SIM profile based on identifying that the identified SIM profile is enabled, and perform, via the NFC circuit based on the identified SIM profile, an NFC communication with the external electronic device.

In an embodiment, in operation 815, the electronic device may enable the identified SIM profile based on identifying that the identified SIM profile is not enabled, change the port connected to the NFC circuit to the port corresponding to the identified SIM profile, and perform, via the NFC circuit based on the identified SIM profile, an NFC communication with the external electronic device.

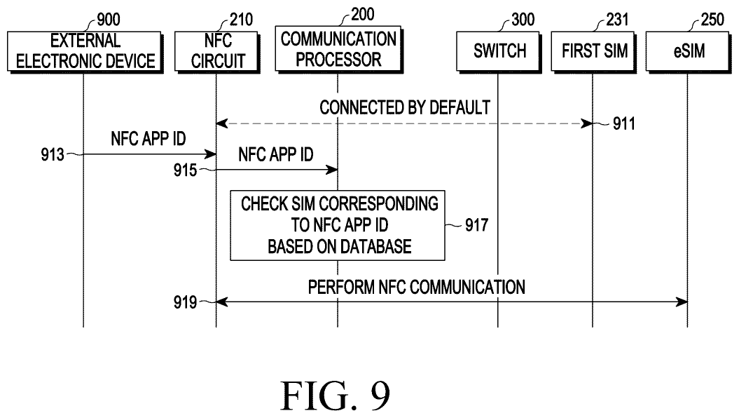

FIG. 9 is a signal flowchart illustrating an example of an operating method of an electronic device in a wireless communication system, according to an embodiment.

Referring to FIG. 9, an electronic device (e.g., the electronic device 101 of FIGS. 1A to 7) may include at least one of an NFC circuit 210 (e.g., the NFC circuit 210 of FIGS. 2 to 7), a communication processor 200 (e.g., the communication processor 200 of FIGS. 2 to 7), a switch 300 (e.g., the switch 300 of FIGS. 3 to 6), a first SIM 231 (e.g., the first SIM 111 of FIG. 1B, or the first SIM 231 of FIGS. 2 to 6), or an eSIM (e.g., the eSIM 196 of FIG. 1B, or the eSIM 250 of FIGS. 2, 4, and 5).

It may be assumed that the NFC circuit 210 is connected to the first SIM 231 (or a first SIM profile) by default (operation 911).

When the NFC circuit 210 is connected to the first SIM 231 by default, the NFC circuit 210 may receive an NFC App ID from an external electronic device 900 (e.g., the electronic device 102 or the electronic device 104 of FIG. 1A). In an embodiment, the external electronic device 900 may be and/or may include a POS device (operation 913).

The NFC circuit 210, which receives the NFC App ID from the external electronic device 900, may transfer the received NFC App ID to the communication processor 200 (operation 915).

The communication processor 200, which receives the NFC App ID from the NFC circuit 210, may check (or identify) a SIM profile in which an NFC App corresponding to the NFC App ID is installed, based on a database including information related to a SIM profile in which at least one NFC App is installed (operation 917). In FIG. 9, it may be assumed that the SIM profile in which the NFC App corresponding to the NFC App ID is installed is a SIM profile corresponding to the eSIM 250.

In an embodiment, information related to a SIM profile in which an NFC App is installed may be generated by at least one of a name of the NFC App, a number of the SIM profile in which the NFC App is installed, or state information indicating whether the SIM profile in which the NFC App is installed is enabled or disabled. In an embodiment, the information related to the SIM profile in which the NFC App is installed may be generated by mapping a service provided by the NFC App as well as the at least one of the name of the NFC App, the number of the SIM profile in which the NFC App is installed, and the state information indicating whether the SIM profile in which the NFC App is installed is enabled or disabled. The database including the information related to the SIM profile in which the at least one NFC App is installed may be implemented similarly to and/or substantially the same as described with reference FIGS. 3 to 7, consequently, a repeated description thereof may be omitted for the sake of brevity.

The communication processor 200, which identifies the SIM profile in which the NFC App corresponding to the NFC App ID is installed, may perform an NFC communication with the external electronic device based on the identified SIM profile via the NFC circuit 210 (operation 919). In FIG. 9, because it has been assumed that the SIM profile in which the NFC App corresponding to the NFC App ID is installed is the SIM profile corresponding to the eSIM 250, the communication processor 200 may connect the NFC circuit 210 and the eSIM 250 via a switch (e.g., the switch 300 of FIGS. 3 to 6), so an NFC communication may be performed based on the SIM profile corresponding to the eSIM 250. An operation of performing the NFC communication with the external electronic device based on the identified SIM profile via the NFC circuit may be implemented similarly to and/or substantially the same as described with reference to FIGS. 3 to 8, consequently, a repeated description thereof may be omitted for the sake of brevity.

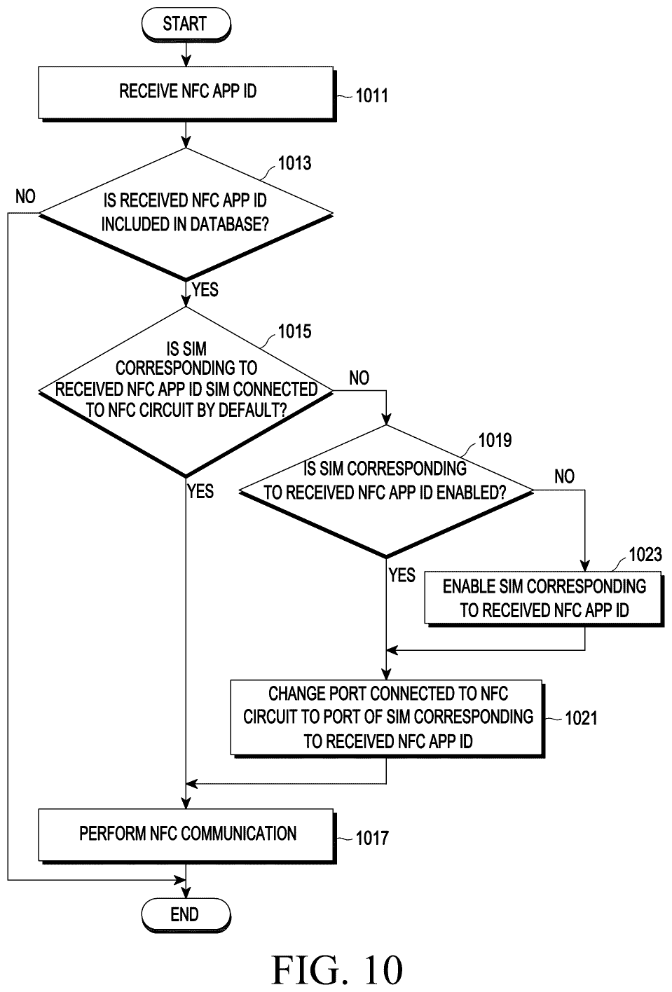

FIG. 10 is a flowchart depicting an example of an operating method of an electronic device, according to an embodiment.

Referring to FIG. 10, the electronic device 101 (e.g., the electronic device 101 of FIGS. 1A to 7) and/or at least one processor (e.g., the processor 120 and/or the communication processor 200 of FIGS. 1A to 7) may receive an NFC App ID from an external electronic device (e.g., the electronic device 102 or the electronic device 104 of FIG. 1A) via an NFC circuit (e.g., the NFC circuit 210 of FIGS. 2 to 7) in operation 1011. In an embodiment, the external electronic device may be and/or may include a POS device.

The electronic device, which receives the NFC App ID from the external electronic device, may identify whether the received NFC App ID is included in a database in operation 1013. In an embodiment, the database may include information related to a SIM profile in which an NFC App is installed. The database including information related to a SIM profile in which at least one NFC App is installed may be implemented similarly to and/or substantially the same as described with reference to FIGS. 3 to 7, consequently, a repeated description thereof may be omitted for the sake of brevity.

As a result of identification in operation 1013, if the received NFC App ID is not included in the database (operation 1013—No), the electronic device may terminate without performing any further operations.

As a result of identification in operation 1013, if the received NFC App ID is included in the database (operation 1013—Yes), the electronic device may identify whether the SIM corresponding to the received NFC App ID is a SIM connected to the NFC circuit by default in operation 1015.

As a result of identification in operation 1015, if the SIM corresponding to the received NFC App ID is the SIM connected to the NFC circuit by default (operation 1015—Yes), the electronic device may perform an NFC communication with the external electronic device based on the SIM profile corresponding to the SIM corresponding to the received NFC App ID without performing a separate port change operation in operation 1017. An operation of performing the NFC communication with the external electronic device based on the SIM profile corresponding to the SIM corresponding to the received NFC App ID when the SIM corresponding to the NFC App ID is the SIM connected to the NFC circuit by default may be implemented similarly to and/or substantially the same as described with reference to FIGS. 3 to 8, consequently, a repeated description thereof may be omitted for the sake of brevity.

As a result of identification in operation 1015, if the SIM corresponding to the received NFC App ID is not the SIM connected to the NFC circuit by default (operation 1015—No), the electronic device may identify whether the SIM corresponding to the received NFC App ID is enabled in operation 1019.

As a result of identification in operation 1019, if the SIM corresponding to the received NFC App ID is enabled (operation 1019—Yes), the electronic device may change a port connected to the NFC circuit to a port of the SIM corresponding to the received NFC App ID in operation 1021. The electronic device, which changes the port connected to the NFC circuit to the port of the SIM corresponding to the received NFC App ID, may proceed to operation 1017.

As a result of identification in operation 1019, if the SIM corresponding to the received NFC App ID is not enabled (operation 1019—No), the electronic device may enable the SIM corresponding to the received NFC App ID in operation 1023 and proceed to operation 1021.

An operation of performing the NFC communication with the external electronic device based on the SIM profile corresponding to the SIM corresponding to the received NFC App ID when the SIM corresponding to the NFC App ID is not the SIM connected to the NFC circuit by default may be implemented similarly to and/or substantially the same as described with reference to FIGS. 3 to 8, consequently, a repeated description thereof may be omitted for the sake of brevity.

According to an embodiment of the disclosure, a method may include receiving an NFC application ID from an external electronic device (e.g., the electronic device 102 or the electronic device 104 of FIG. 1A).

According to an embodiment of the disclosure, the method may include identifying a SIM profile, from among a plurality of SIM profiles, which corresponds to the NFC application ID.

According to an embodiment of the disclosure, the method may include performing an NFC communication with the external electronic device based on the identified SIM profile.

According to an embodiment of the disclosure, identifying the SIM profile, from among the plurality of SIM profiles, that corresponds to the NFC application ID may include identifying the SIM profile, among the plurality of SIM profiles, that corresponds to the NFC application ID based on a database including information related to at least one SIM profile in which at least one NFC application is installed.

According to an embodiment of the disclosure, an NFC application corresponding to the NFC application ID may be installed in the identified SIM profile.

According to an embodiment of the disclosure, performing the NFC communication with the external electronic device based on the identified SIM profile may include identifying whether the identified SIM profile is enabled.

According to an embodiment of the disclosure, performing the NFC communication with the external electronic device based on the identified SIM profile may include, based on identifying that the identified SIM profile is disabled, enabling the identified SIM profile and performing the NFC communication with the external electronic device by enabling the identified SIM profile.

According to an embodiment of the disclosure, performing the NFC communication with the external electronic device based on the identified SIM profile may include disabling the identified SIM profile after the NFC communication is performed. According to an embodiment of the disclosure, performing the NFC communication with the external electronic device based on the identified SIM profile may include enabling the identified SIM profile based on identifying that the identified SIM profile is disabled.

According to an embodiment of the disclosure, performing the NFC communication with the external electronic device based on the identified SIM profile may include performing the NFC communication with the external electronic device by enabling the identified SIM profile.

According to an embodiment of the disclosure, performing the NFC communication with the external electronic device based on the identified SIM profile may include identifying whether the identified SIM profile is enabled.

According to an embodiment of the disclosure, performing the NFC communication with the external electronic device based on the identified SIM profile may include identifying whether a SIM corresponding to the identified SIM profile is connected to an NFC circuit 210 via a switch 300, based on identifying that the identified SIM profile is enabled.

According to an embodiment of the disclosure, performing the NFC communication with the external electronic device based on the identified SIM profile may include performing the NFC communication with the external electronic device based on the identified SIM profile, based on identifying that the SIM corresponding to the identified SIM profile is connected to the NFC circuit 210 via the switch 300.

According to an embodiment of the disclosure, the switch 300 may connect the NFC circuit 210 to one of at least two among a first SIM, a second SIM, or an eSIM.

According to an embodiment of the disclosure, the database may be generated by mapping, to each of the at least one NFC application, a name of an NFC application, a number of a SIM profile in which the NFC application is installed, and state information indicating whether the SIM profile in which the NFC application is installed is enabled or disabled.

According to an embodiment of the disclosure, a storage medium storing at least one computer-readable instruction may be provided.

According to an embodiment of the disclosure, the at least one instruction, when executed by at least one processor (e.g., the processor 120 and/or the communication processor 200 of FIGS. 1A to 7) of an electronic device 101, may cause the electronic device 101 to perform at least one operation.

According to an embodiment of the disclosure, the at least one operation may include receiving an NFC application ID from the external electronic device.

According to an embodiment of the disclosure, the at least one operation may include identifying a SIM profile, from among a plurality of SIM profiles, that corresponds to the NFC application ID.

According to an embodiment of the disclosure, the at least one operation may include performing an NFC communication with the external electronic device based on the identified SIM profile.

While embodiments of the disclosure have been described, it may be apparent to those of ordinary skill in the art that various changes and modifications may be made thereto without departing from the spirit and scope of the disclosure as set forth in the following claims.

What is claimed is:

1. An electronic device comprising:
a near field communication (NFC) circuit;
at least one processor operatively connected to the NFC circuit; and
memory storing instructions that, when executed by the at least one processor, cause the electronic device to:
receive, via the NFC circuit from an external electronic device, an NFC application identifier (ID),
identify a subscriber identity module (SIM) profile, from among a plurality of SIM profiles, that corresponds to the NFC application ID, and
perform, via the NFC circuit, an NFC communication with the external electronic device based on the identified SIM profile.

2. The electronic device of claim 1, wherein the instructions stored in the memory, when executed by the at least one processor, further cause the electronic device to:
identify the SIM profile, from among the plurality of SIM profiles, that corresponds to the NFC application ID based on a database comprising information related to at least one SIM profile in which at least one NFC application is installed, and
wherein an NFC application corresponding to the NFC application ID is installed in the identified SIM profile.

3. The electronic device of claim 1, wherein the instructions stored in the memory, when executed by the at least one processor, further cause the electronic device to:
identify whether the identified SIM profile is enabled, and
based on identifying that the identified SIM profile is disabled, enable the identified SIM profile, perform via the NFC circuit, the NFC communication with the external electronic device, and disable the identified SIM profile based on the NFC communication being completed.

4. The electronic device of claim 1, wherein the instructions stored in the memory, when executed by the at least one processor, further cause the electronic device to:
based on identifying that the identified SIM profile is disabled, enable the identified SIM profile, and
perform, via the NFC circuit, the NFC communication with the external electronic device by enabling the identified SIM profile.

5. The electronic device of claim 1, further comprising:
a switch operatively coupled with the at least one processor,
wherein the instructions stored in the memory, when executed by the at least one processor, further cause the electronic device to:
identify whether the identified SIM profile is enabled,
based on identifying that the identified SIM profile is enabled, identify whether a SIM corresponding to the identified SIM profile is connected to the NFC circuit via the switch, and
based on identifying that the SIM corresponding to the identified SIM profile is connected to the NFC circuit via the switch, perform, via the NFC circuit, the NFC communication with the external electronic device based on the identified SIM profile, and
wherein the switch is configured to connect the NFC circuit to one of at least two of a first SIM, a second SIM, or an embedded subscriber identity module (eSIM).

6. The electronic device of claim 5, wherein the instructions stored in the memory, when executed by the at least one processor, further cause the electronic device to:
based on identifying that the SIM corresponding to the identified SIM profile is not connected to the NFC circuit via the switch, connect the SIM corresponding to the identified SIM profile to the NFC circuit via the switch, and
perform, via the NFC circuit, the NFC communication with the external electronic device based on the identified SIM profile.

7. The electronic device of claim 5, wherein the instructions stored in the memory, when executed by the at least one processor, further cause the electronic device to:
based on identifying that the identified SIM profile is disabled, enable the identified SIM profile;
identify whether a SIM corresponding to the identified SIM profile is connected to the NFC circuit via the switch, and
based on identifying that the SIM corresponding to the identified SIM profile is connected to the NFC circuit via the switch, perform, via the NFC circuit, the NFC communication with the external electronic device based on the identified SIM profile.

8. The electronic device of claim 7, wherein the instructions stored in the memory, when executed by the at least one processor, further cause the electronic device to:
based on identifying that the SIM corresponding to the identified SIM profile is not connected to the NFC circuit via the switch, connect the SIM corresponding to the identified SIM profile to the NFC circuit via the switch, and
perform, via the NFC circuit, the NFC communication with the external electronic device based on the identified SIM profile.

9. The electronic device of claim 1, wherein the identified SIM profile is comprised in a multiple enabled profile (MEP) eSIM comprising at least two SIM profiles,
wherein a port is allocated to each of the at least two SIM profiles, and
wherein the instructions stored in the memory, when executed by the at least one processor, further cause the electronic device to:
identify whether a port corresponding to the identified SIM profile is connected to the NFC circuit, and
based on identifying that the port corresponding to the identified SIM profile is connected to the NFC circuit, perform, via the NFC circuit, the NFC communication with the external electronic device based on the identified SIM profile.

10. The electronic device of claim 9, wherein the instructions stored in the memory, when executed by the at least one processor, further cause the electronic device to:
based on identifying that the port corresponding to the identified SIM profile is not connected to the NFC circuit, identify whether the identified SIM profile is enabled,
based on identifying that the identified SIM profile is enabled, change the port connected to the NFC circuit to another port corresponding to the identified SIM profile, and
perform, via the NFC circuit, the NFC communication with the external electronic device based on the identified SIM profile.

11. The electronic device of claim 10, wherein the instructions stored in the memory, when executed by the at least one processor, further cause the electronic device to:
based on identifying that the identified SIM profile is disabled, enable the identified SIM profile,
change the port connected to the NFC circuit to the another port corresponding to the identified SIM profile, and
perform, via the NFC circuit, the NFC communication with the external electronic device based on the identified SIM profile.

12. The electronic device of claim 10, wherein the instructions stored in the memory, when executed by the at least one processor, further cause the electronic device to:
based on identifying termination of the NFC communication, change the port connected to the NFC circuit from the port corresponding to the identified SIM profile to another port previously coupled with the NFC circuit before the port corresponding to the identified SIM profile.

13. The electronic device of claim 2, wherein the instructions stored in the memory, when executed by the at least one processor, further cause the electronic device to:
generate the database by mapping, to each of the at least one NFC application, a name of the NFC application, identification information of a SIM profile in which the NFC application is installed, and state information indicating whether the SIM profile in which the NFC application is installed is enabled.

14. The electronic device of claim 13, wherein the instructions stored in the memory, when executed by the at least one processor, further cause the electronic device to:
generate the database by mapping a service provided by the NFC application to each of the at least one NFC application.

15. A method comprising:
receiving, from an external electronic device, a near field communication (NFC) application identifier (ID);
identifying a subscriber identity module (SIM) profile, from among a plurality of SIM profiles, that corresponds to the NFC application ID; and
performing an NFC communication with the external electronic device based on the identified SIM profile.

16. The method of claim 15, wherein the identifying the SIM profile comprises:
identifying the SIM profile based on a database comprising information related to at least one SIM profile in which at least one NFC application is installed, and
wherein an NFC application corresponding to the NFC application ID is installed in the identified SIM profile.

17. The method of claim 15, wherein the performing of the NFC communication comprises:
identifying whether the identified SIM profile is enabled; and
based on identifying that the identified SIM profile is disabled, enabling the identified SIM profile and performing the NFC communication with the external electronic device by enabling the identified SIM profile.

18. The method of claim 15, wherein the performing the NFC communication comprises:
based on identifying that the identified SIM profile is disabled, enabling the identified SIM profile; and
performing the NFC communication with the external electronic device by enabling the identified SIM profile.

19. The method of claim 15, wherein the performing of the NFC communication comprises:
identifying whether the identified SIM profile is enabled;
based on identifying that the identified SIM profile is enabled, identifying whether a SIM corresponding to the identified SIM profile is connected to an NFC circuit via a switch; and
based on identifying that the SIM corresponding to the identified SIM profile is connected to the NFC circuit via the switch, performing the NFC communication with the external electronic device based on the identified SIM profile, and
wherein the switch connects the NFC circuit to one of at least two of a first SIM, a second SIM, or an embedded subscriber identity module (eSIM).

20. The method of claim 16, further comprising:
generating the database by mapping, to each of the at least one NFC application, a name of the NFC application, a number of a SIM profile in which the NFC application is installed, and state information indicating whether the SIM profile in which the NFC application is installed is enabled.
